(19) United States
(12) Patent Application Publication
(10) Pub. No.: US 2026/0244314 A1
(43) Pub. Date: Aug. 20, 2026

(54) INFORMATION PROCESSING METHOD AND APPARATUS, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventors: Chushi WEI, Shenzhen (CN); Qian QIU, Shenzhen (CN); Xing LIN, Shenzhen (CN); Ying QI, Shenzhen (CN); Binbin WANG, Shenzhen (CN); Shangzhen ZHENG, Shenzhen (CN); Jiaqi HUANG, Shenzhen (CN)

(73) Assignee: Tencent Technology (Shenzhen) Company Limited, Shenzhen (CN)

(21) Appl. No.: 19/640,492

(22) Filed: Apr. 7, 2026

Related U.S. Application Data
(63) Continuation of application No. PCT/CN2025/082953, filed on Mar. 17, 2025.

(30) Foreign Application Priority Data
Mar. 27, 2024 (CN) 202410366238.X

(51) Int. Cl. G06F 3/0483; G06F 16/11

(52) U.S. Cl. CPC G06F 3/0483; G06F 16/128; G06F 2203/04803

(57) ABSTRACT

An information processing method, apparatus, and computer-readable storage medium for managing unread information across client pages. The method displays a first page with an entry to a second page and an incremental quantity representing total unread information received since the second page was last displayed. Upon triggering the entry, the second page displays multiple information categories with stock quantities representing accumulated unread information per category. When new information arrives after displaying the second page, corresponding stock quantities are updated, and the incremental quantity is refreshed. The system handles both split-screen and single-screen display modes, maintains cached page data for efficient updates, and coordinates with server-side counters to accurately track unread information across page hierarchies and display states.

### CROSS-REFERENCE TO RELATED APPLICATIONS

This application is a continuation application of International Application No. PCT/CN2025/082953 filed on March 17, 2025 which claims priority to Chinese Patent Application No. 202410366238.X, filed with the China National Intellectual Property Administration on March 27, 2024, the disclosures of each being incorporated by reference herein in their entireties.

### FIELD

The disclosure relates to the field of communication technologies, an information processing method and apparatus, an electronic device, a computer-readable storage medium, and a computer program product.

### BACKGROUND

With the rapid development of Internet technologies, there are more and more applications, and a user may receive a large amount of unread information, with quantities of pieces of unread information displayed on pages of the applications. In a related technology, the user may click each piece of unread information to reduce the quantities of pieces of unread information displayed on the pages. A process of reducing the quantity of pieces of unread information may be complex, and excessive accumulation of unread information leads to information overload. In addition, excessive elimination operations increase load of a database, and consume system resources and a network bandwidth, causing low information processing efficiency and increasing waiting duration.

### SUMMARY

Provided are an information processing method and apparatus, a device, a storage medium, and a program product, which can implement intelligent unread information tracking through incremental and stock quantity management across multiple page levels and display modes.

According to some embodiments, an information processing method, performed by an electronic device, includes: displaying a first page of a client, the first page comprising an entry to a second page and an incremental quantity of unread information, the incremental quantity of unread information including a total quantity of unread information received since the second page is displayed last time; displaying, based on a trigger operation on the entry to the second page, the second page comprising a plurality of information categories and a stock quantity of unread information for each of the plurality of information categories, and each respective stock quantity represents an accumulated quantity of unread information in a corresponding information category; and updating, based on receiving new information of at least one information category after the second page is displayed, a stock quantity of unread information corresponding to the at least one information category, and updating the incremental quantity of unread information.

According to some embodiments, an information processing apparatus, includes: at least one memory configured to store program code; and at least one processor configured to read the program code and operate as instructed by the program code, the program code including: first display code configured to cause at least one of the at least one processor to display a first page of a client, the first page comprising an entry to a second page and an incremental quantity of unread information, the incremental quantity of unread information including a total quantity of unread information received since the second page is displayed last time; second display code configured to cause at least one of the at least one processor to display, based on a trigger operation on the entry to the second page, the second page comprising a plurality of information categories and a stock quantity of unread information for each of the plurality of information categories, and each respective stock quantity represents an accumulated quantity of unread information in a corresponding information category; and updating code configured to cause at least one of the at least one processor to update, based on receiving new information of at least one information category after the second page is displayed, a stock quantity of unread information corresponding to the at least one information category, and update the incremental quantity of unread information.

According to some embodiments, a non-transitory computer-readable storage medium, storing computer code which, when executed by at least one processor, causes the at least one processor to at least: display a first page of a client, the first page comprising an entry to a second page and an incremental quantity of unread information, the incremental quantity of unread information including a total quantity of unread information received since the second page is displayed last time; display, based on a trigger operation on the entry to the second page, the second page comprising a plurality of information categories and a stock quantity of unread information for each of the plurality of information categories, and each respective stock quantity represents an accumulated quantity of unread information in a corresponding information category; and update, based on receiving new information of at least one information category after the second page is displayed, a stock quantity of unread information corresponding to the at least one information category, and update the incremental quantity of unread information.

Some embodimentsSome embodimentsSome embodimentsSome embodimentsSome embodiments.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of skill in the art may still derive other drawings from these accompanying drawings without creative efforts. In addition, one of skill would understand that aspects of some embodiments may be combined together or implemented alone.

FIG. 1 is a schematic diagram of an architecture of an information processing system 100 according to some embodiments.

FIG. 2 is a schematic diagram of a structure of a terminal 400 according to some embodiments.

FIG. 3A is a first schematic flowchart of an information processing method according to some embodiments.

FIG. 3B is a second schematic flowchart of an information processing method according to some embodiments.

FIG. 3C is a third schematic flowchart of an information processing method according to some embodiments.

FIG. 3D is a fourth schematic flowchart of an information processing method according to some embodiments.

FIG. 3E is a fifth schematic flowchart of an information processing method according to some embodiments.

FIG. 3F is a sixth schematic flowchart of an information processing method according to some embodiments.

FIG. 3G is a seventh schematic flowchart of an information processing method according to some embodiments.

FIG. 3H is an eighth schematic flowchart of an information processing method according to some embodiments.

FIG. 4A is a schematic diagram of a first application of an information processing method according to some embodiments.

FIG. 4B is a schematic diagram of a second application of an information processing method according to some embodiments.

FIG. 4C is a schematic diagram of a third application of an information processing method according to some embodiments.

FIG. 4D is a schematic diagram of a fourth application of an information processing method according to some embodiments.

FIG. 4E is a schematic diagram of a fifth application of an information processing method according to some embodiments.

FIG. 5A is a schematic diagram of a sixth application of an information processing method according to some embodiments.

FIG. 5B is a schematic diagram of a seventh application of an information processing method according to some embodiments.

FIG. 5C is a schematic diagram of an eighth application of an information processing method according to some embodiments.

FIG. 5D is a schematic diagram of a ninth application of an information processing method according to some embodiments.

FIG. 5E is a schematic diagram of a tenth application of an information processing method according to some embodiments.

FIG. 5F is a schematic diagram of an eleventh application of an information processing method according to some embodiments.

FIG. 6 is a schematic diagram of a principle of unidirectional control in a related technology according to some embodiments.

FIG. 7 is a schematic diagram of a principle of a solution for delivering an incremental red dot according to some embodiments.

FIG. 8 is a diagram of a structure of a counter according to some embodiments.

The foregoing "first" and "second" are only used to distinguish between different solutions, and do not represent superiorities-inferiorities of the solutions or priorities of the solutions in an implementation process.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of skill in the art without creative efforts shall fall within the protection scope of the present disclosure.

In the following descriptions, related "some embodiments" describe a subset of all possible embodiments. However, it may be understood that the "some embodiments" may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In the following descriptions, related "some embodiments" describe a subset of all possible embodiments. However, the "some embodiments" may be the same subset or different subsets of all the possible embodiments, and may be combined with each other without conflict.

The term "first/second/third" involved in the following descriptions is merely for distinguishing between similar objects and does not indicate a order of the objects. "First/second/third" may be transposed in a order or a sequence when allowed, so that some embodiments described herein may be implemented in an order other than those illustrated or described herein.

In some embodiments, the term "module" or "unit" is a computer program with a preset function or a part of a computer program and operates, together with other related parts, to implement a preset target, and may be completely or partially implemented by using software, hardware (for example, a processing circuit or a memory), or a combination thereof. Similarly, one processor (or a plurality of processors or memories) may be configured to implement one or more modules or units. In addition, each module or unit may be a part of an overall module or unit including a function of the module or the unit.

Unless otherwise specified, "at least one" described below means one or more, and "a plurality of" means two or more.

Unless otherwise defined, meanings of all technical and scientific terms used in this specification are the same as those usually understood by a person skilled in the art to which this application belongs. The terms used in this specification are merely intended to describe the objectives of some embodiments, but are not intended to limit this application.

In some embodiments, during example application of relevant data collection and processing, an informed consent or individual consent of a personal information subject may be obtained in strict accordance with the requirements of relevant national laws and regulations, and a subsequent data use and processing behavior is carried out within the scope of authorization of laws and regulations and the personal information subject.

Before some embodiments are further described in detail, descriptions are made on nouns and terms in some embodiments, and the nouns and terms in some embodiments are applicable to the following explanations.

(1) A first page is a page including at least one function item or a function presentation page of a function item in a client, where the function item includes "live", "short videos", "news subscription", "games", and "shopping". The first page may include a plurality of levels of subpages having a level-by-level jump relationship. Except a last level of subpage, each level of subpage includes an entry to a next level of subpage.

(2) An information category means classification of various types of notifications or interactions received by a user in social media, a content platform, an application, or another online service. Categories help the user organize and manage the notifications, so that the user can quickly identify and respond to different types of information. The information category includes at least one of the following: comments, likes, follows, shares, and favorites.

(3) A second page is a page that may be entered through a jump or displayed by using the first page and that includes a plurality of information categories. If the first page includes the plurality of levels of subpages, the last level of subpage of the first page includes an entry to the second page, and the second page is displayed in response to a trigger operation on the entry to the second page. The entry to the second page has a plurality of representation forms, for example, may be a profile picture of the user or an arrow.

(4) A third page is a page including all unread information of any information category. The second page includes entries to third pages respectively corresponding to the plurality of information categories.

(5) An incremental quantity of pieces of unread information is a total quantity of pieces of unread information received by the client after the second page is displayed on the client last time. For example, 50 pieces of unread information are displayed on the first page. After the second page is displayed, no unread information is displayed on the first page. When 20 pieces of unread information are received subsequently, the total quantity 20 of pieces of unread information received is displayed on the first page, for example, the incremental quantity of pieces of unread information is 20.

(6) A stock quantity of pieces of unread information means quantities of pieces of unread information separately accumulated in the plurality of information categories on the second page. For example, if there are received five pieces of unread information of the information category "likes", six pieces of unread information of the information category "comments", and seven pieces of unread information of the information category "follows", stock quantities of pieces of unread information corresponding to the information category "likes", the information category "comments", and the information category "follows" are 5, 6, and 7.

(7) A counter is a data storage structure that is configured in a server to record a quantity of pieces of unread information. The counter includes a plurality of sub-counters. Each sub-counter corresponds to one information category. The plurality of sub-counters are configured to respectively count unread information of the plurality of information categories.

(8) Snapshot data is data recorded by the counter running in the server corresponding to the client when the second page is displayed. The snapshot data includes quantities (for example, first count values) of pieces of unread information of the plurality of information categories at a moment (for example, a first time stamp) at which the second page is displayed.

(9) A split-screen display mode is a mode in which a plurality of pages are displayed on a same screen, and allows simultaneous display of a plurality of pages on a screen of one client for the user. For example, the first page and the second page are simultaneously displayed in response to the trigger operation on the entry to the second page on the first page. Sizes of the first page and the second page may be the same. Alternatively, a ratio of sizes of the first page and the second page may be a ratio of quantities of pieces of content displayed on the first page and the second page.

(10) A single-screen display mode is a mode in which only one page is displayed on one screen at a time. For example, the first page is displayed; and in response to the trigger operation on the entry to the second page on the first page, the first page is hidden, and the second page is displayed.

(11) An interactive notification is a carrier of a quantity of pieces of unread information, for example, the quantity of pieces of unread information may be encapsulated in the interactive notification. The interactive notification has a plurality of representation forms. For example, the interactive notification may be a red circle, and the quantity of pieces of unread information is displayed in the red circle.

(12) A point-to-point message is information transmitted only between two users, and is a type of information. The point-to-point message is not forwarded by a central server. Such a communication mode allows real-time and private communication between the users, and is usually used for instant messaging, file sharing, and other applications that require direct connections. An information type further includes a group message.

(13) "In response to" is configured for representing a condition or status on which one or more to-be-performed operations depend. When the condition or status is satisfied, the one or more operations may be performed in real time, or may be performed after a set delay. Unless particularly described, there is no chronological order between the plurality of to-be-performed operations.

(14) A human-computer interaction interface is an interface for providing a human-computer interaction function or an interface for presenting a page and information.

For example, a graphical user interface (GUI) is presented as, for example, an augmented reality (AR) interface, a virtual reality (VR) interface, a voice user interface (VUI), an interactive projection interface (displaying information on a plane by using a projection technology), an eye movement detection interface (an interface controlled by detecting a line of sight of a user), a holographic interface (a three-dimensional hologram formed by projecting an image by using a holographic projection technology, where a three-dimensional image can be seen without wearing special glasses), a multi-modal interface (an interaction interface combining a plurality of interaction manners, such as tactile, visual, and auditory), and a brain-machine interface (BMI).

In a related technology, a user usually may click each piece of unread information in sequence, a quantity of pieces of unread information displayed on a page can be reduced only after message content is displayed, and only a total quantity of pieces of unread information is displayed on the page. Consequently, an interaction path is excessively long, a process of reducing the quantity of pieces of unread information is complex, and excessive accumulation of unread information affects user experience.

Based on the foregoing analysis, the applicant finds that in an information processing method in the related technology, a quantity of pieces of unread information displayed on an outer page cannot be updated when content of information is not viewed. For the foregoing problem, some embodiments provides an information processing method, to quickly update the quantity of pieces of unread information, improving user experience.

Some embodiments provide an information processing method and apparatus, an electronic device, a computer-readable storage medium, and a computer program product, to quickly update a quantity of pieces of unread information, improving user experience. The following describes exemplary applications of the electronic device provided in some embodiments. The electronic device provided in some embodiments may be implemented as various types of terminals such as a notebook computer, a tablet computer, a desktop computer, a set-top box, a smartphone, a smart speaker, a smartwatch, a smart television, and an in-vehicle terminal, or may be implemented as a server. The following describes an exemplary application by implementing the electronic device as a terminal.

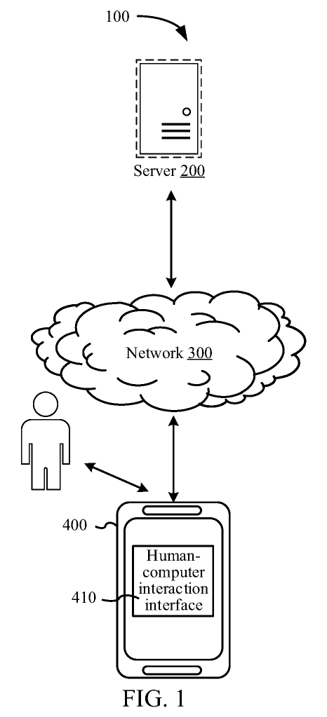

Referring to FIG. 1, FIG. 1 is a schematic diagram of an architecture of an information processing system 100 according to some embodiments. To support an information processing application, a terminal 400 is connected to a server 200 through a network 300. The network 300 may be a wide area network, a local area network, or a combination thereof.

The terminal 400 is configured to: display a first page of a client in a human-computer interaction interface 410, the first page including an entry to a second page and an incremental quantity of pieces of unread information; display the second page in response to a trigger operation on the entry to the second page, the second page including a plurality of information categories and stock quantities of pieces of unread information respectively corresponding to the plurality of information categories, and the stock quantities of pieces of unread information being quantities of pieces of unread information accumulated in the information categories; and update, based on new information of at least one information category in response to receiving the new information of the at least one information category after the second page is displayed, a stock quantity of pieces of unread information corresponding to the at least one information category, and update the incremental quantity of pieces of unread information. The server 200 is configured to count unread information and transmit a quantity of pieces of unread information to the terminal 400 for displaying in the human-computer interaction interface 410 of the terminal 400.

In some embodiments, the server 200 may be an independent physical server, a server cluster or distributed system including a plurality of physical servers, or a cloud server providing a cloud computing service such as a cloud service, a cloud database, cloud computing, a cloud function, cloud storage, a network service, cloud communication, a middleware service, a domain name service, a security service, a content delivery network (CDN), and a big data and artificial intelligence platform. The terminal and the server may be connected directly or indirectly in a wired or wireless communication mode. This is not limited in some embodiments.

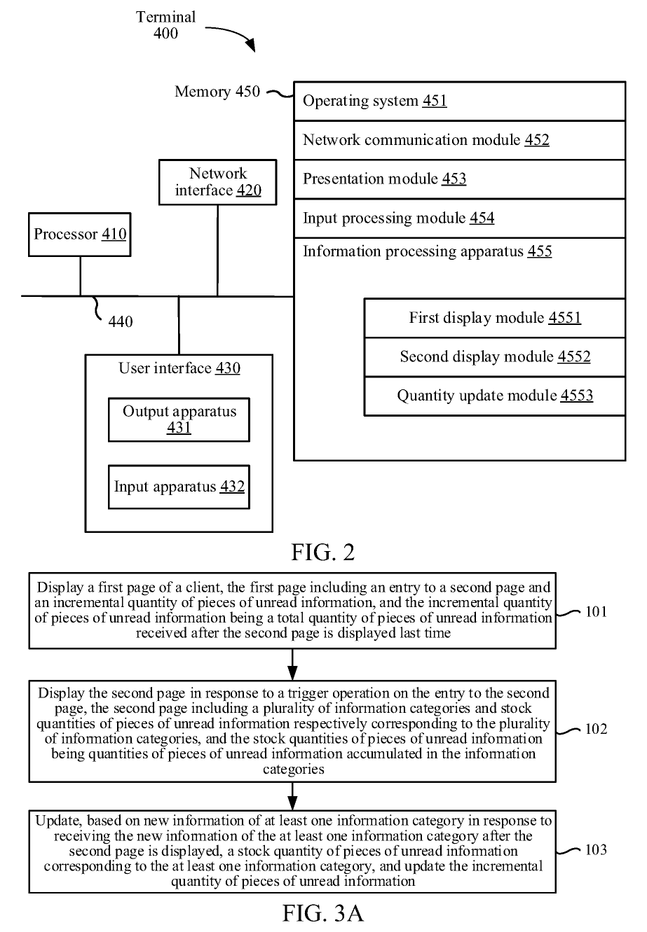

Referring to FIG. 2, FIG. 2 is a schematic diagram of a structure of the terminal 400 according to some embodiments. The terminal 400 shown in FIG. 2 includes at least one processor 410, a memory 450, at least one network interface 420, and a user interface 430. The components of the terminal 400 are coupled together via a bus system 440. The bus system 440 is configured to implement connection and communication between the components. In addition to a data bus, the bus system 440 further includes a power bus, a control bus, and a status signal bus. However, for clarity of description, various buses are marked as the bus system 440 in FIG. 2.

The processor 410 may be an integrated circuit chip with a signal processing capability, such as a general-purpose processor, a digital signal processor (DSP), another programmable logic device, a discrete gate or transistor logic device, or a discrete hardware component. The general-purpose processor may be a microprocessor, any processor, or the like.

The user interface 430 includes one or more output apparatuses 431 that can present medium content, including one or more speakers and/or one or more visual display screens. The user interface 430 further includes one or more input apparatuses 432, including a user interface component that facilitates user input, such as a keyboard, a mouse, a microphone, a touchscreen, a camera, and other input buttons and controls.

The memory 450 may be removable, irremovable, or a combination thereof. For example, a hardware device includes a solid-state memory, a hard disk drive, an optical disk drive, and the like. In some embodiments, the memory 450 includes one or more storage devices physically located away from the processor 410.

The memory 450 includes a volatile memory or a non-volatile memory, or may include both a volatile memory and a non-volatile memory. The non-volatile memory may be a read-only memory (ROM), and the volatile memory may be a random access memory (RAM). The memory 450 described in some embodiments is intended to include any suitable type of memory.

In some embodiments, the memory 450 can store data to support various operations. Examples of the data include a program, a module, a data structure, or a subset or a superset thereof, which are described below by way of example.

An operating system 451 includes system programs configured for processing various system services and performing hardware-related tasks, for example, a framework layer, a core library layer, and a driver layer, and is configured to implement various services and process hardware-based tasks.

A network communication module 452 is configured to reach another electronic device through one or more (wired or wireless) network interfaces 420. For example, the network interface 420 includes Bluetooth, wireless fidelity (Wi-Fi), and a universal serial bus (USB).

A presentation module 453 is configured to present information through the one or more output apparatuses 431 (for example, a display screen or a speaker) associated with the user interface 430 (for example, a user interface for operating a peripheral device and displaying content and information).

An input processing module 454 is configured to detect one or more user inputs or interactions from one of the one or more input apparatuses 432 and translate the detected inputs or interactions.

In some embodiments, the apparatus provided in some embodiments may be implemented in a software manner. FIG. 2 shows an information processing apparatus 455 stored in the memory 450. The apparatus may be software in a form of a program, a plug-in, or the like, and includes the following software modules: a first display module 4551, a second display module 4552, and a quantity update module 4553. These modules are logical modules, and therefore may be combined or further split in any manner based on implemented functions. Functions of the modules are described below.

In some embodiments, the terminal or the server may implement the information processing method provided in some embodiments by running various computer-executable instructions or computer programs. For example, the computer-executable instructions may be microprogram-level commands, machine instructions, or software instructions. The computer program may be a native program or a software module in the operating system; may be a native application (APP), for example, a program that may be installed in the operating system to run, such as a live broadcast APP or an instant messaging APP; or may be a mini program that may be embedded in any APP, for example, a program that only may be downloaded into a browser environment to run. In a word, the foregoing computer-executable instructions may be any form of instructions, and the computer program may be any form of application, module, or plug-in.

The information processing method provided in some embodiments is described with reference to the exemplary applications and implementations of the terminal provided in some embodiments.

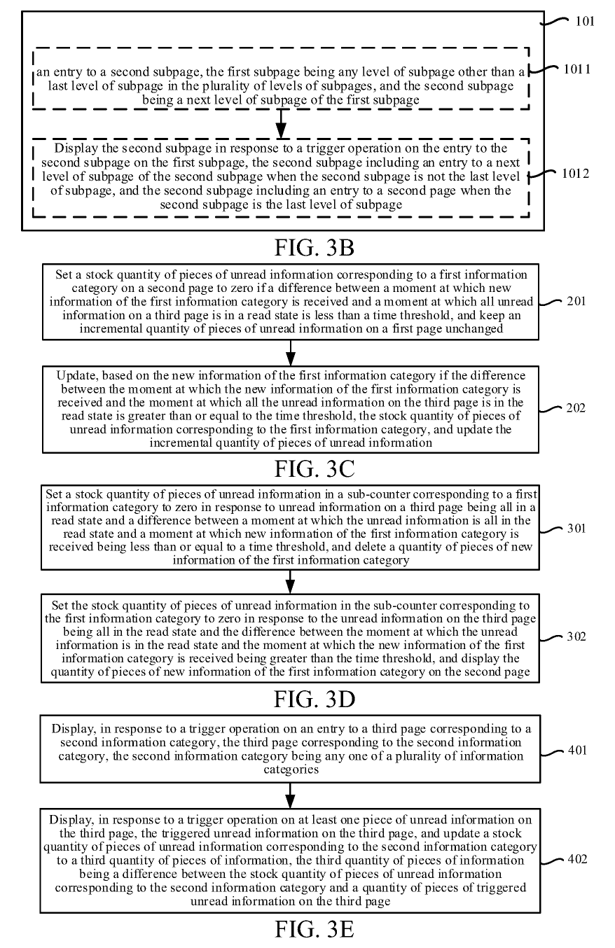

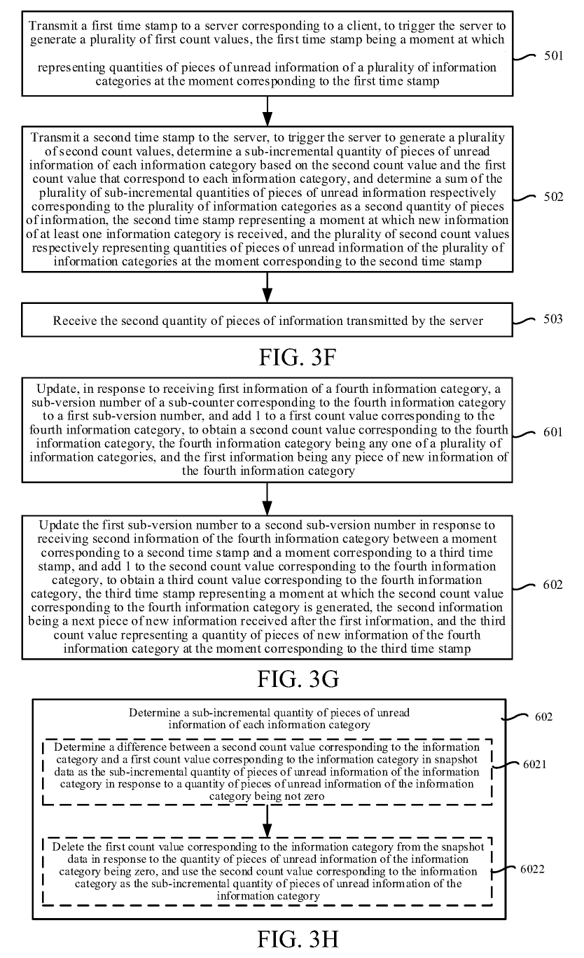

Referring to FIG. 3A, FIG. 3A is a first schematic flowchart of the information processing method according to some embodiments. With the terminal as a body, descriptions are provided with reference to operations shown in FIG. 3A.

Operation 101: Display a first page of a client, the first page including an entry to a second page and an incremental quantity of pieces of unread information, and the incremental quantity of pieces of unread information being a total quantity of pieces of unread information received after the second page is displayed last time.

In some embodiments, the client may display pages in a single-screen mode or a multi-screen mode. The client may be an instant messaging client. The first page may be a function aggregation page in the instant messaging client, and may include multiple function items, for example, function items such as "live", "short videos", "news subscription", "games", and "shopping". Each function item corresponds to a plurality of information categories. In a region corresponding to each function item, an incremental quantity of pieces of unread information of the corresponding function item may be displayed. The incremental quantity of pieces of unread information may be carried in an incremental unread interactive notification. The incremental quantity of pieces of unread information is a total quantity of pieces of information that is in an unread state and that is received after the second page is displayed last time. A representation form of the incremental unread interactive notification may be a number only, or may be a combination of a number and another graphic element, where the another graphic element may be a colored (for example, striking red) circle or a plus sign.

For example, a moment at which the second page is displayed last time is 10:30, a current moment is 11:00, and between 10:30 and 11:00, a quantity of pieces of unread information received by the function item "live" is 5, a quantity of pieces of unread information received by the function item "short videos" is 0, a quantity of pieces of unread information received by the function item "news subscription" is 1, a quantity of pieces of unread information received by the function item "games" is 3, and a quantity of unread information received by the function item "shopping" is 2. In this case, the total quantity of pieces of unread information received after the second page is displayed last time is 5+0+1+3+2=11, for example, the incremental quantity of pieces of unread information is 11.

In some embodiments, the first page includes a plurality of levels of subpages having a level-by-level jump relationship. "A plurality of levels" means two or more levels. Each of the plurality of levels of subpages includes the incremental quantity of pieces of unread information. Referring to FIG. 3B, FIG. 3B is a second schematic flowchart of the information processing method according to some embodiments. The "displaying a first page of a client" in operation 101 in FIG. 3A may be implemented by using operation 1011 and operation 1012 in FIG. 3B. Details are described below.

Operation 1011: Display a first subpage in the plurality of levels of subpages, the first subpage including an entry to a second subpage, the first subpage being any level of subpage other than a last level of subpage in the plurality of levels of subpages, and the second subpage being a next level of subpage of the first subpage.

In some embodiments, two levels of subpages are used as an example. The first subpage may be a page including a plurality of function items, and the second subpage, for example, the last level of subpage, may be a detail page corresponding to any function item. An entry to a second subpage corresponding to each function item may be designed in a form of a button, a card, a list item, or the like. A red circle may be displayed on the entry to the second subpage corresponding to each function item. The red circle includes a quantity of pieces of unread information of an information category corresponding to the function item, and is configured for prompting the user that there is new unread information in the information category.

For example, when the function item is "short videos", the first subpage includes the function item "short videos" and the entry to the second subpage corresponding to the function item "short videos". In response to a trigger operation on the entry to the second subpage corresponding to the function item "short videos", the second subpage is displayed. The second subpage may be a detail page of "short videos", and a short video may be switched on the second subpage through a slide operation.

Operation 1012: Display the second subpage in response to a trigger operation on the entry to the second subpage on the first subpage, the second subpage including an entry to a next level of subpage of the second subpage when the second subpage is not the last level of subpage, and the second subpage including the entry to the second page when the second subpage is the last level of subpage.

In some embodiments, the second subpage further includes an entry to a previous level of subpage of the second subpage, and the previous level of subpage of the second subpage is displayed in response to a trigger operation on the entry to the previous level of subpage. The trigger operation may be in any one of the following forms: a click, a touch and hold, a slide, and a voice command.

As an example, an entry to any level of subpage may be displayed at an upper right corner of a previous level of subpage, and the entry may have a plurality of display forms, such as a red circle or an arrow. For example, the form of the entry is a red circle, and the red circle may include the incremental quantity of pieces of unread information. Each level of subpage includes the same incremental quantity of pieces of unread information.

In some embodiments, a level-by-level jump design can reduce loading time of an initial page, improve a response speed and performance of an application, and implement gradual in-depth query of content, avoiding information overload. A clear level-by-level jump relationship can help a user better understand a structure of the application and reduce a possibility of getting lost. Each page includes the incremental quantity of pieces of unread information, so that a total quantity of pieces of unread information can be indicated to the user in real time, improving information management efficiency.

Still referring to FIG. 3A, in operation 102, the second page is displayed in response to a trigger operation on the entry to the second page, the second page including a plurality of information categories and stock quantities of pieces of unread information respectively corresponding to the plurality of information categories, and the stock quantities of pieces of unread information being quantities of pieces of unread information accumulated in the information categories.

In some embodiments, the first page may include entries respectively corresponding to a plurality of second pages. In response to a trigger operation on an entry to any second page, the second page corresponding to the triggered entry is displayed.

As an example, the second page includes the plurality of information categories, such as comments, likes, follows, shares, and favorites. By triggering any function item on the first page, a second page corresponding to the function item is obtained.

In some embodiments, when the first page includes the plurality of levels of subpages, the last level of subpage of the first page includes the entry to the second page, and the second page is displayed in response to the trigger operation on the entry to the second page.

Still in the example of operation 1012, when the second subpage is the last level of subpage, the second subpage includes the entry to the second page, and the second page is displayed in response to the trigger operation on the entry to the second page on the second subpage.

Operation 103: Update, based on new information of at least one information category in response to receiving the new information of the at least one information category after the second page is displayed, a stock quantity of pieces of unread information corresponding to the at least one information category, and update the incremental quantity of pieces of unread information.

In some embodiments, the following processing is performed in parallel or in series based on the new information of the at least one information category in response to receiving the new information, for example, new unread information, of the at least one information category after the second page is displayed and before a third page is entered: updating the stock quantity of pieces of unread information corresponding to the at least one information category, for example, superimposing a quantity to the stock quantity of pieces of unread information before the second page is displayed: each time a piece of new information of an information category is received, adding 1 to a stock quantity of pieces of unread information of the information category on the second page; and updating the incremental quantity of pieces of unread information, for example, setting the incremental quantity of pieces of unread information before display of the second page to zero, and then superimposing a quantity of pieces of unread information: each time a pieces of new information of any information category is received, adding 1 to the incremental quantity of pieces of unread information on the first page.

Still in the example of operation 101, the current moment is 11:00, the current moment being a moment after the second page is displayed and before the third page is entered. The second page is a page corresponding to the function item "short videos". The information categories include "likes", "comments", "favorites", and "reposts". Before the second page is displayed, if a stock quantity of pieces of unread information corresponding to "likes" is 1, a stock quantity of pieces of unread information corresponding to "comments" is 3, a stock quantity of pieces of unread information corresponding to "favorites" is 5, and a stock quantity of pieces of unread information corresponding to "reposts" is 2, the incremental quantity of pieces of unread information is 1+3+5+2=11. After the second page is displayed and before the third page is entered, if there is received one piece of new information of the category "likes", zero pieces of new information of the category "comments", two pieces of new information of the category "favorites", and one piece of new information of the category "reposts", the stock quantities of pieces of unread information respectively corresponding to "likes", "comments", "favorites", and "reposts" are updated, for example, the stock quantity of pieces of unread information corresponding to "likes" is 2, the stock quantity of pieces of unread information corresponding to "comments" is 3, the stock quantity of pieces of unread information corresponding to "favorites" is 7, and the stock quantity of pieces of unread information corresponding to "reposts" is 3; and the incremental quantity 11 of pieces of unread information before display of the second page is set to zero, and quantities of pieces of new information respectively corresponding to "likes", "comments", "favorites", and "reposts" are summed as 1+0+2+1=4. In this case, the incremental quantity of pieces of unread information is updated to 4.

In some embodiments, the "updating a stock quantity of pieces of unread information corresponding to the at least one information category" in operation 103 may be implemented by performing the following operation: updating, for each of the plurality of information categories, the stock quantity of pieces of unread information corresponding to the information category to a first quantity of pieces of information, the first quantity of pieces of information being a sum of the stock quantity of pieces of unread information corresponding to the information category and a quantity of pieces of new information of the information category.

As an example, the client may calculate the first quantity of pieces of information. Alternatively, the client may report the stock quantity of pieces of unread information corresponding to the information category to a server corresponding to the client, and then the server calculates the first quantity of pieces of information and transmits the first quantity of pieces of information to the client, to trigger the client to perform updating.

In some embodiments, the "updating the incremental quantity of pieces of unread information" in operation 103 may be implemented by performing the following operation: updating the incremental quantity of pieces of unread information to a second quantity of pieces of information, the second quantity of pieces of information being a total quantity of pieces of new information of the at least one information category.

As an example, updating the incremental quantity of pieces of unread information to the second quantity of pieces of information is replacing, for the incremental quantity of pieces of unread information when the new information of the at least one information category is received after the second page is displayed, the incremental quantity of pieces of unread information before the second page is entered with the second quantity of pieces of information. If there are a plurality of pieces of new information, new information of each information category is added, to obtain the second quantity of pieces of information.

In some embodiments, when the client is in a split-screen display mode, the first page and the second page are both in a displayed state. The "updating the incremental quantity of pieces of unread information to a second quantity of information" includes: updating the incremental quantity of pieces of unread information displayed on the first page to the second quantity of pieces of information in response to the client being in the split-screen display mode.

Still in the example of operation 103, the incremental quantity of pieces of unread information before the second page is displayed is 11, and after the second page is displayed and the new information is received, the incremental quantity of pieces of unread information is updated to 4, for example, the second quantity of pieces of information is 4. When the client is in the split-screen display mode, and the new information is received, the stock quantity of pieces of unread information corresponding to each information category on the second page and the incremental quantity of pieces of unread information displayed on the first page are synchronously updated, for example, the incremental quantity of pieces of unread information displayed on the first page is updated to the second quantity 4 of pieces of information.

In some embodiments, the first page and the second page are both visible in the split-screen display mode, so that the incremental quantity of pieces of unread information may be updated in real time. This enables the user to instantly see an update of the incremental quantity of pieces of unread information on the first page while viewing content on the second page, improving real-time performance of the information. The screen-split mode allows the user to simultaneously perform a plurality of tasks, for example, browse other content while viewing a message. The quantity of pieces of unread information updated in real time can help the user learn whether there is new important information that may be processed without leaving a current task. Because the incremental quantity of pieces of unread information is updated on the first page in real time, the user does not need to switch pages frequently to check new messages, reducing interference and improving working efficiency.

In some embodiments, when the client is in a single-screen display mode, and the second page is in a displayed state, the first page is in a hidden state. The "updating the incremental quantity of pieces of unread information to a second quantity of information" may be implemented in the following manner: updating the incremental quantity of pieces of unread information in cached page data of the first page to the second quantity of pieces of information in response to the client being in the single-screen display mode, the cached page data of the first page being configured for performing page refresh when the first page is switched to a displayed state.

Still in the example of operation 103, the incremental quantity of pieces of unread information before the second page is displayed is 11, and after the second page is displayed and the new information is received, the incremental quantity of pieces of unread information is updated to 4, for example, the second quantity of pieces of information is 4. When the client is in the single-screen display mode, and the new information is received, the stock quantity of pieces of unread information corresponding to each information category on the second page and the incremental quantity of pieces of unread information in the cached page data of the first page are synchronously updated, for example, the incremental quantity of pieces of unread information in the cached page data of the first page is updated to the second quantity 4 of pieces of information, and the second quantity 4 of pieces of information is displayed on the first page in response to a trigger operation on an entry to the first page.

In some embodiments, when the second page is in the display state in the single-screen display mode, the first page is in the hidden state. The incremental quantity of pieces of unread information in the cached page data of the first page may be updated to keep information updated without occupying additional resources. When the user switches from the second page back to the first page, a latest quantity incremental of pieces of unread information may be quickly refreshed and displayed on the first page, so that page switching efficiency is improved, and waiting time of the user is reduced. The incremental quantity of pieces of unread information in the cached page data is updated, so that it is ensured for the user that the incremental quantity of pieces of unread information on the first page is up-to-date in any display mode, maintaining consistency and accuracy of the information. In the single-screen display mode, data of the incremental quantity of pieces of unread information does not need to be frequently requested from the server, so that network bandwidth is saved.

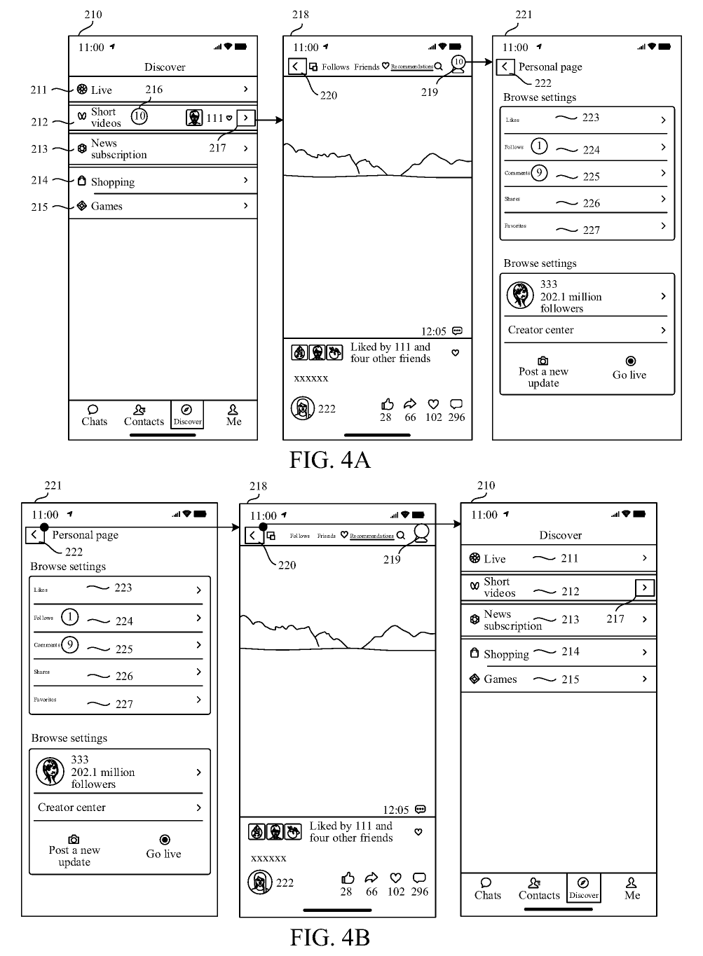

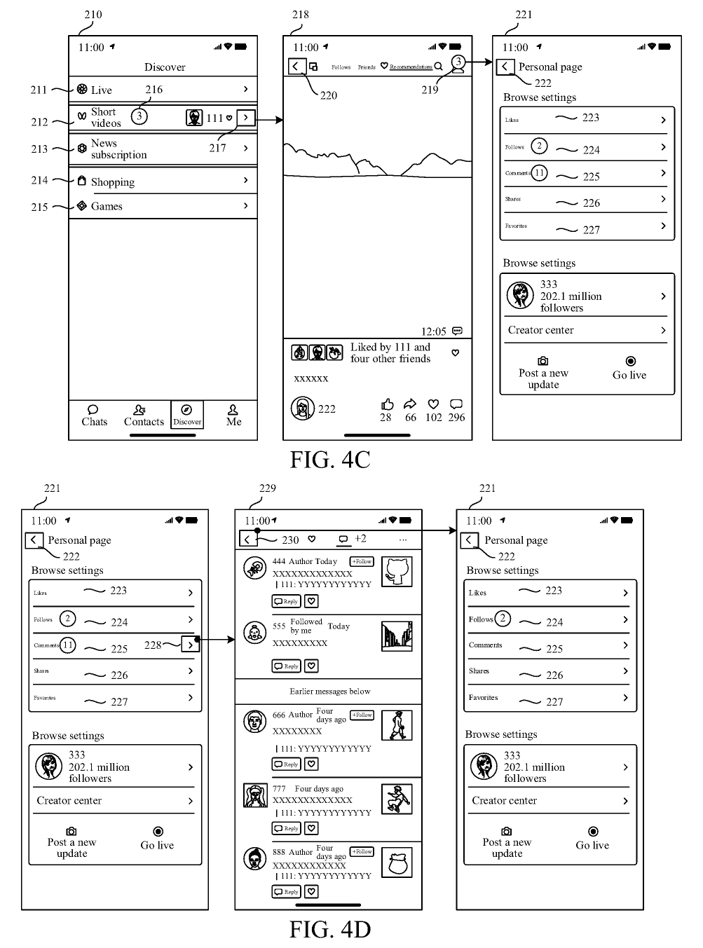

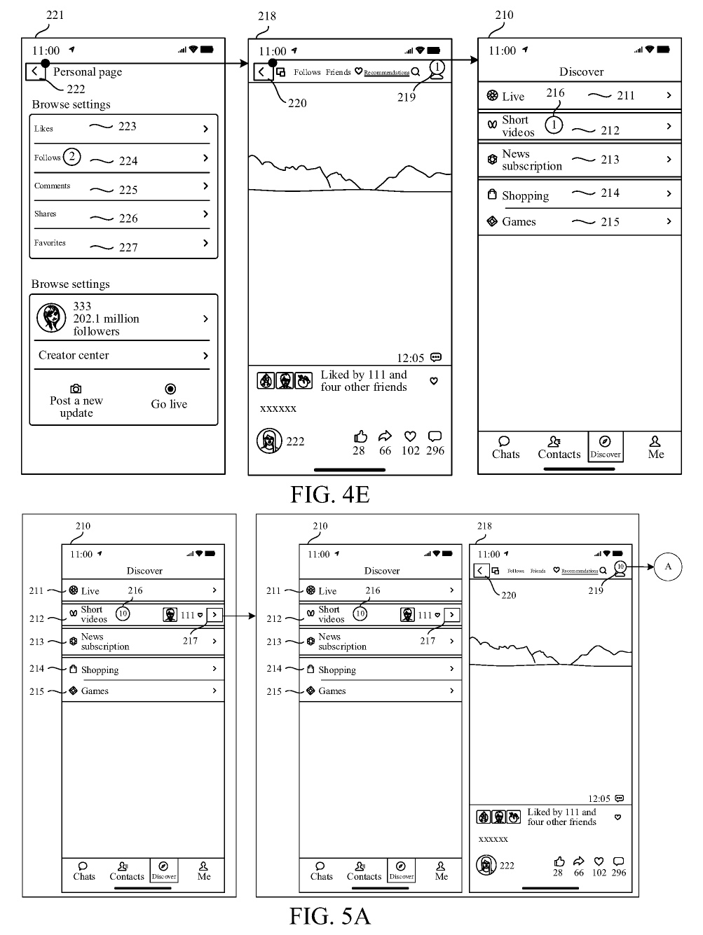

As an example of operation 101 to operation 103, the client may be in the single-screen display mode. Referring to FIG. 4A, FIG. 4A is a schematic diagram of a first application of the information processing method according to some embodiments. If the first page includes the plurality of levels of subpages, for example, two levels of subpages, a first subpage 210 of the first page of the client is displayed in a left figure of FIG. 4A. The first subpage 210 includes a plurality of function items, for example, a function item 211, a function item 212, a function item 213, a function item 214, and a function item 215. Each function item on the first subpage 210 may include an entry to a second subpage corresponding to the function item, for example, an entry 217 to the second subpage, and an incremental quantity of pieces of unread information in a circular icon 216. For example, the incremental quantity of pieces of unread information is 10. A second subpage 218, for example, the last level of subpage, is displayed in a middle figure of FIG. 4A in response to a trigger operation on the entry 217 to the second subpage. The second subpage 218 includes an entry 219 to the second page and an entry 220 for returning to the first subpage. The incremental quantity 10 of pieces of unread information may be displayed in a circular icon in the entry 219 to the second page. The second subpage 218 is a second subpage corresponding to the function item 211. A second page 221 is displayed in a right figure of FIG. 4A in response to a trigger operation on the entry 219 to the second page. The second page 221 includes an entry 222 for returning to the second subpage and a plurality of information categories, for example, an information category 223, an information category 224, an information category 225, an information category 226, and an information category 227. Behind each information category, there is a stock quantity of pieces of unread information corresponding to the information category, for example, a stock quantity 1 of pieces of unread information corresponding to the information category 224 and a stock quantity 9 of pieces of unread information corresponding to the information category 225.

As an example of operation 101 to operation 103, referring to FIG. 4B, FIG. 4B is a schematic diagram of a second application of the information processing method according to some embodiments. After the second page 221 is displayed in a left figure of FIG. 4B, the second subpage 218 is displayed in a middle figure of FIG. 4B in response to a trigger operation on the entry 222 for returning to the second subpage. In this case, the incremental quantity of pieces of unread information on the second subpage is 0. The first subpage 210 is displayed in a right figure of FIG. 4B in response to a trigger operation on the entry 220 for returning to the first subpage. In this case, an incremental quantity of pieces of unread information corresponding to the function item 212 is 0.

As an example of operation 101 to operation 103, referring to FIG. 4C, FIG. 4C is a schematic diagram of a third application of the information processing method according to some embodiments. In response to receiving new information of at least one information category after the second page is displayed, for example, a quantity of pieces of new information of the information category 224 is 1, a quantity of pieces of new information of the information category 225 is 2, and a total quantity of pieces of new information is 3, in a left figure of FIG. 4C, if all the new information belongs to the function item 212, the incremental quantity of pieces of unread information is displayed to be 3 in the circular icon 216 on the first subpage 210. In response to a trigger operation on the entry 217 to the second subpage, in a middle figure of FIG. 4C, the incremental quantity of pieces of unread information is displayed to be 3 in the entry 219 to the second page on the second subpage 218. In response to a trigger operation on the entry 219 to the second page, in a right figure of FIG. 4C, on the second page 221, the stock quantity of pieces of unread information corresponding to the information category 224 is updated to 2, and the stock quantity of pieces of unread information corresponding to the information category 225 is updated to 11.

In some embodiments, the second page further includes entries to third pages respectively corresponding to the plurality of information categories. After the "displaying the second page" in operation 102, the following operation may be further performed: displaying, in response to a trigger operation on an entry to a third page corresponding to a first information category, the third page corresponding to the first information category, and setting a stock quantity of pieces of unread information corresponding to the first information category on the third page to zero, the first information category being any one of the plurality of information categories.

As an example, referring to FIG. 4D, FIG. 4D is a schematic diagram of a fourth application of the information processing method according to some embodiments. In a left figure of FIG. 4D, when the second page 221 is displayed, the second page 221 includes the entries of the third pages respectively corresponding to the plurality of information categories, for example, an entry 228 to a third page corresponding to the information category 225. In response to a trigger operation on the entry 228 to the third page corresponding to the information category 225, in a middle figure of FIG. 4D, a third page 229 corresponding to the first information category 225 is displayed, and the stock quantity 11 of pieces of unread information corresponding to the first information category on the third page is set to zero. The third page 229 further includes an entry 230 for returning to the second page. In response to a trigger operation on the entry 230 to the second page, in a right figure of FIG. 4D, the stock quantity of pieces of unread information corresponding to the first information category 225 on the second page 221 is zero.

As an example, referring to FIG. 4E, FIG. 4E is a schematic diagram of a fifth application of the information processing method according to some embodiments. In a left figure of FIG. 4E, the quantity of pieces of new information of the information category 224 is 1, and the quantity of pieces of new information of the information category 225 is 2. After the stock quantity of pieces of unread information of the information category 225 is set to zero on the second page 221, in response to a trigger operation on the entry 222 of returning to the second subpage, in a middle figure of FIG. 4E, the second subpage 218 is displayed, and on the second subpage 218, the incremental quantity of pieces of unread information included in the entry 219 to the second page is updated to 1. In response to a trigger operation on the entry 220 for returning to the first subpage, in a right figure of FIG. 4E, the first subpage 210 is displayed, and the incremental quantity of pieces of unread information included in the circular icon 216 behind the function item 212 on the first subpage 210 is updated to 1.

In some embodiments, referring to FIG. 3C, FIG. 3C is a third schematic flowchart of the information processing method according to some embodiments. After the "displaying the third page corresponding to the first information category" in the foregoing embodiment, operation 201 and operation 202 in FIG. 3C may be further performed in response to receiving new information of the first information category after the third page is displayed. Details are described below.

Operation 201: Set the stock quantity of pieces of unread information corresponding to the first information category on the second page to zero if a difference between a moment at which the new information of the first information category is received and a moment at which all unread information on the third page is in a read state is less than a time threshold, and keep the incremental quantity of pieces of unread information on the first page unchanged.

For example, the stock quantity of pieces of unread information corresponding to the first information category on the second page is 11 after the moment at which the new information of the first information category is received and before the moment at which all the unread information on the third page is in the read state, a quantity of pieces of new information of the first information category is 3, and the time threshold is 5 seconds. In this case, if the difference between the moment at which the new information of the first information category is received and the moment at which all the unread information on the third page is in the read state is 3 seconds, the stock quantity of pieces of unread information corresponding to the first information category on the second page is set to zero, and the incremental quantity 3 of pieces of unread information on the first page is kept unchanged.

Operation 202: Update, based on the new information of the first information category if the difference between the moment at which the new information of the first information category is received and the moment at which all the unread information on the third page is in the read state is greater than or equal to the time threshold, the stock quantity of pieces of unread information corresponding to the first information category, and update the incremental quantity of pieces of unread information.

For example, the stock quantity of pieces of unread information corresponding to the first information category on the second page is 11 after the moment at which the new information of the first information category is received and before the moment at which all the unread information on the third page is in the read state, a quantity of pieces of new information of the first information category is 3, and the time threshold is 5 seconds. In this case, if the difference between the moment at which the new information of the first information category is received and the moment at which all the unread information on the third page is in the read state is 8 seconds, the stock quantity of pieces of unread information corresponding to the first information category on the second page is updated to 14, and the incremental quantity of pieces of unread information on the first page is first set to zero and then added with 3, for example, the incremental quantity of pieces of unread information on the first page is updated to 3.

In some embodiments, the server corresponding to the client includes a counter, the counter includes a plurality of sub-counters, and the plurality of sub-counters are configured to respectively count unread information of the plurality of information categories. Referring to FIG. 3D, FIG. 3D is a fourth schematic flowchart of the information processing method according to some embodiments. After the "displaying the third page corresponding to the first information category" in the foregoing embodiment, a notification that unread information on the third page is in a read state is transmitted to the server immediately after the third page is entered or after all unread information on the third page is triggered, to trigger the server to perform operation 301 and operation 302 in FIG. 3D. Details are described below.

Operation 301: Set the stock quantity of pieces of unread information in a sub-counter corresponding to the first information category to zero in response to the unread information on the third page being all in the read state and a difference between a moment at which the unread information is all in the read state and a moment at which new information of the first information category is received being less than or equal to a time threshold, and delete a quantity of pieces of new information of the first information category.

For example, the stock quantity of pieces of unread information corresponding to the first information category on the second page is 11 when the unread information on the third page is all in the read state, a quantity of pieces of new information of the first information category is 3, and the time threshold is 5 seconds. In this case, if the difference between the moment at which the new information of the first information category is received and the moment at which all the unread information on the third page is in the read state is 3 seconds, the stock quantity 11 of pieces of unread information corresponding to the first information category on the second page is updated to zero, and the quantity 3 of pieces of new information of the first information category is deleted.

Herein, the time threshold may be obtained by performing the following processing: collecting operation data of the user in the client, and analyzing a behavior pattern of the user in the application. For example, for each user, statistics may be collected on time required by the user to read one piece of information on average, and a time interval for the user to open an application again after the user finishes reading information. Reading time of all users is averaged to obtain total average reading time, and the average reading time plus buffer time (for example, 5 seconds) is used as the time threshold. Alternatively, time distribution of user session intervals is analyzed to find most common session interval time, and a time threshold that can cover session intervals of most users (for example, 80% of users) may be selected. For example, a median or a 75 quantile of the session interval time may be selected as the time threshold.

Operation 302: Set the stock quantity of pieces of unread information in the sub-counter corresponding to the first information category to zero in response to the unread information on the third page being all in the read state and the difference between the moment at which the unread information is in the read state and the moment at which the new information of the first information category is received being greater than the time threshold, and display the quantity of pieces of new information of the first information category on the second page.

For example, the stock quantity of pieces of unread information corresponding to the first information category on the second page is 11 when the unread information on the third page is all in the read state, a quantity of pieces of new information of the first information category is 3, and the time threshold is 5 seconds. In this case, if the difference between the moment at which the new information of the first information category is received and the moment at which all the unread information on the third page is in the read state is 8 seconds, the stock quantity 11 of pieces of unread information in the sub-counter corresponding to the first information category is updated to zero, and the quantity 3 of pieces of new information of the first information category is displayed on the second page.

In some embodiments, an independent sub-counter is set for each information category, so that a quantity of pieces of unread information of each information category can be accurately managed, helping the user to learn an information status of each information category more clearly. The time threshold is set, to set the stock quantity of pieces of unread information corresponding to the first information category on the second page to zero at the moment when the unread information on the third page is all in the read state when the new information of the first information category is received within the time threshold, avoiding repeated processing of the new information, reducing a stored data amount, optimizing use of storage resources, reducing unnecessary data storage and transmission, and saving system resources and bandwidth.

In some embodiments, the second page further includes entries to third pages respectively corresponding to the plurality of information categories. Referring to FIG. 3E, FIG. 3E is a fifth schematic flowchart of the information processing method according to some embodiments. After the "displaying the second page" in operation 102 in FIG. 3A, operation 401 and operation 402 in FIG. 3E may be further performed. Details are described below.

Operation 401: Display, in response to a trigger operation on an entry to a third page corresponding to a second information category, the third page corresponding to the second information category, the second information category being any one of the plurality of information categories.

In some embodiments, different second information categories correspond to different third pages, the third page includes the entry to the second page, and the second page is displayed in response to a trigger operation on the entry to the second page on the third page.

For example, an example in which the second page is a page displaying a personal information center is used. The plurality of information categories include "likes", "comments", "favorites", and "reposts". The second information category is any information category of "likes", "comments", "favorites", and "reposts". In response to a trigger operation on an entry to a third page corresponding to "likes", the third page corresponding to "likes" is displayed, for example, the third page includes a plurality of pieces of like information, for example, "User B likes your video at 13:00".

Operation 402: Display, in response to a trigger operation on at least one piece of unread information on the third page, the triggered unread information on the third page, and update a stock quantity of pieces of unread information corresponding to the second information category to a third quantity of pieces of information, the third quantity of pieces of information being a difference between the stock quantity of pieces of unread information corresponding to the second information category and a quantity of pieces of triggered new information on the third page.

Still in the example of operation 401, for the third page corresponding to the second information category "likes", there are four pieces of unread information in total on the third page, for example, a stock quantity of pieces of unread information corresponding to the second information category "likes" is 4, for example, information A, information B, information C, and information D. In response to trigger operations on the information A and the information B, the triggered information A and information B are displayed in sequence. In this case, the quantity of pieces of triggered unread information on the third page is 2, and a difference between the stock quantity of pieces of unread information corresponding to the second information category "likes" and the quantity of triggered unread information on the third page is 4–2 = 2, for example, the third quantity of pieces of information is 2. The stock quantity 4 of pieces of unread information corresponding to the second information category is updated to the third quantity 2 of pieces of information.

In some embodiments, an account of a first object is logged in on the third page. The at least one piece of unread information is information transmitted by a second object. The at least one piece of unread information is sorted in descending order of a preset sorting parameter. The sorting parameter includes at least one of the following: receiving time of the unread information, a similarity between the first object and the second object corresponding to the unread information, an interaction frequency between the first object and the second object corresponding to the unread information, and interaction duration between the first object and the second object corresponding to the unread information.

For example, the similarity is used as an example. A first object feature of the first object and a second object feature of the second object are obtained. The first object feature is vectorized to obtain a first vector. The second object feature is vectorized to obtain a second vector. A similarity between the first vector and the second vector is determined as the similarity between the first object and the second object corresponding to the unread information. The similarity may be determined by using any one of the following algorithms: a cosine similarity, a Euclidean distance, a Manhatton distance, or a Pearson correlation coefficient.

In some embodiments, the entries to the third pages respectively corresponding to the plurality of information categories are provided, so that the user can quickly access third pages corresponding to different information categories, improving convenience in navigation. When the user reads or marks information as read, the stock quantity of pieces of unread information is updated in real time, to ensure that the user sees a latest unread information status. The user can view detailed content only by clicking the unread information, and the quantity of pieces of unread information is updated automatically, so that an operation procedure is simplified, and a response speed is improved.

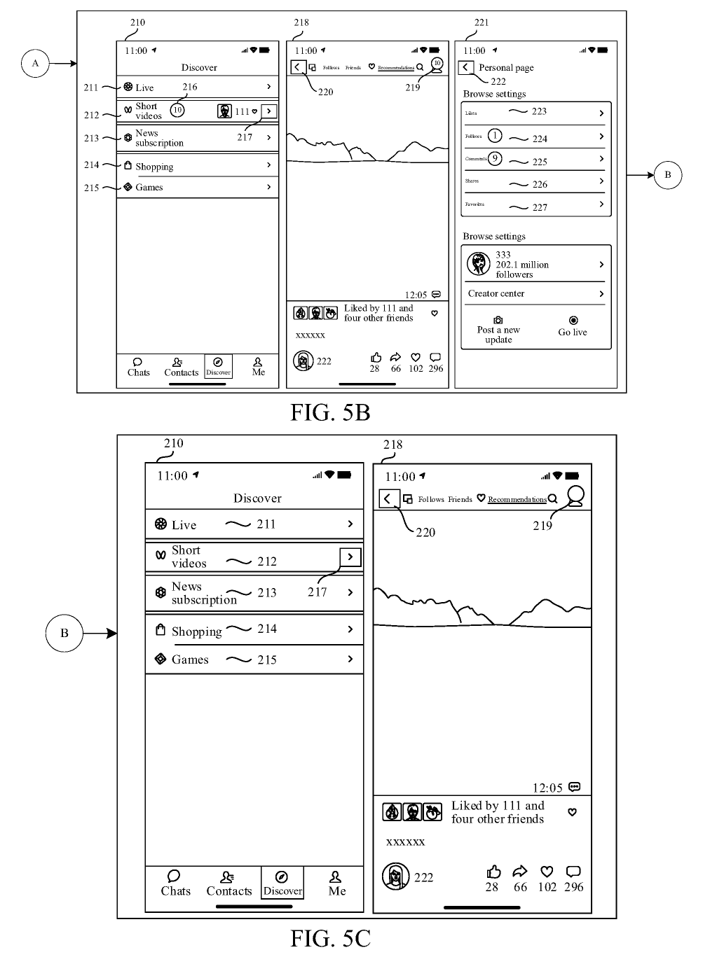

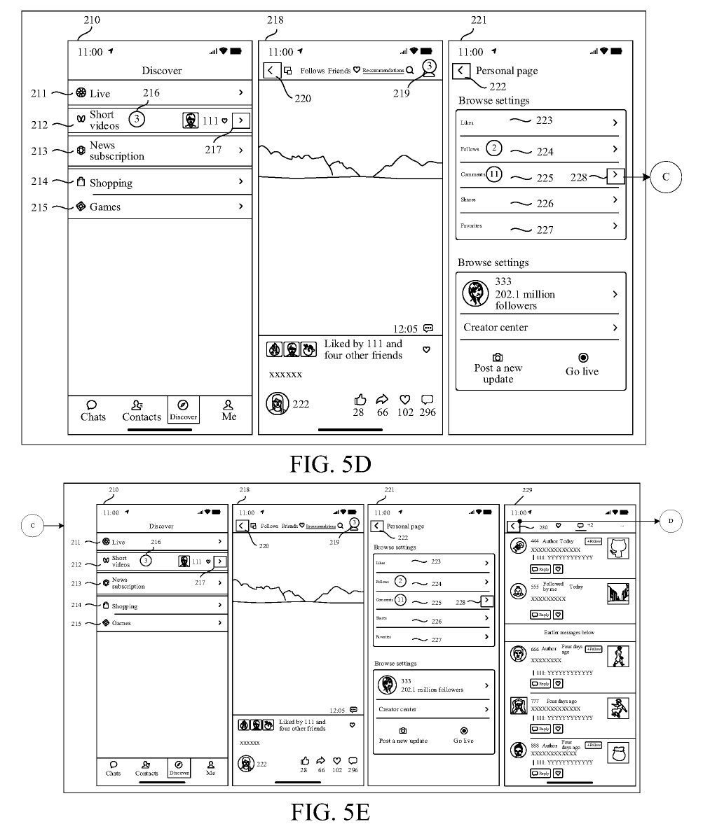

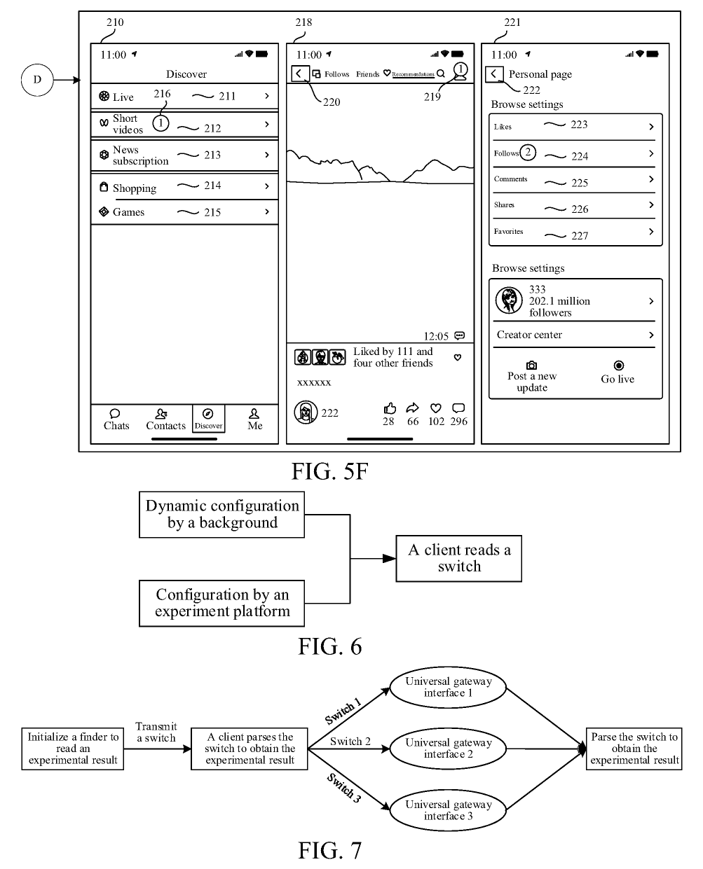

As an example of the foregoing embodiment, the client may be in a multi-screen display mode. Referring to FIG. 5A, FIG. 5A is a schematic diagram of a sixth application of the information processing method according to some embodiments. If the first page includes the plurality of levels of subpages, for example, two levels of subpages, a first subpage 210 of the first page of the client is displayed in a left figure of FIG. 5A. The first subpage 210 includes a plurality of function items, for example, a function item 211, a function item 212, a function item 213, a function item 214, and a function item 215. Each function item on the first subpage 210 may include an entry to a second subpage corresponding to the function item, for example, an entry 217 to the second subpage, and an incremental quantity of pieces of unread information in a circular icon 216. For example, the incremental quantity of pieces of unread information is 10. The first subpage 210 and a second subpage 218 are displayed on a same screen in a middle figure of FIG. 5A in response to a trigger operation on the entry 217 to the second subpage. The second subpage 218 is the last level of subpage. The second subpage 218 includes an entry 219 to the second page and an entry 220 for returning to the first subpage. The incremental quantity 10 of pieces of unread information may be displayed in a circular icon in the entry 219 to the second page. The second subpage 218 is a second subpage corresponding to the function item 211. In response to a trigger operation on the entry 219 to the second page, the first subpage and the second subpage shown in FIG. 5A are switched to the first subpage, the second subpage, and the second page shown in FIG. 5B for displaying.

As an example of the foregoing embodiment, referring to FIG. 5B, FIG. 5B is a schematic diagram of a seventh application of the information processing method according to some embodiments. In FIG. 5B, the first subpage 210, the second subpage 218, and a second page 221 are displayed on the same screen. The second page 221 includes an entry 222 for returning to the second subpage and a plurality of information categories, for example, an information category 223, an information category 224, an information category 225, an information category 226, and an information category 227. Behind each information category, there is a stock quantity of pieces of unread information corresponding to the information category, for example, a stock quantity 1 of pieces of unread information corresponding to the information category 224 and a stock quantity 9 of pieces of unread information corresponding to the information category 225. After the second page is displayed, in response to a trigger operation on the entry 222 for returning to the second subpage, the first subpage, the second subpage, and the second page shown in FIG. 5B are switched to the first subpage and the second subpage shown in FIG. 5C for displaying.

As an example of the foregoing embodiment, referring to FIG. 5C, FIG. 5C is a schematic diagram of an eighth application of the information processing method according to some embodiments. In FIG. 5C, the second page is hidden, and the first subpage 210 and the second subpage 218 are displayed on the same screen. In this case, the incremental quantity of pieces of unread information on the second subpage 218 is 0, and an incremental quantity of pieces of unread information corresponding to the function item 212 on the first subpage 210 is 0.

As an example of the foregoing embodiment, referring to FIG. 5D, FIG. 5D is a schematic diagram of a ninth application of the information processing method according to some embodiments. In response to receiving new information of at least one information category after the second page is displayed, for example, a quantity of pieces of new information of the information category 224 is 1, a quantity of pieces of new information of the information category 225 is 2, and a total quantity of pieces of new information is 3, in FIG. 5D, the first subpage 210, the second subpage 218, and the second page 221 are displayed on the same screen. If all the new information belongs to the function item 212, the incremental quantity of pieces of unread information is displayed to be 3 in the circular icon 216 on the first subpage 210. The incremental quantity of pieces of unread information is displayed to be 3 in the entry 219 to the second page on the second subpage 218. On the second page 221, the stock quantity of pieces of unread information corresponding to the information category 224 is updated to 2, and the stock quantity of pieces of unread information corresponding to the information category 225 is updated to 11. When the second page 221 is displayed, the second page 221 includes entries to third pages respectively corresponding to the plurality of information categories, for example, an entry 228 to a third page corresponding to the information category 225. In response to a trigger operation on the entry 228 to the third page corresponding to the information category 225, the first subpage, the second subpage, and the second page shown in FIG. 5D are switched to the first subpage, the second subpage, the second page, and the third page shown in FIG. 5E for displaying.

As an example of the foregoing embodiment, referring to FIG. 5E, FIG. 5E is a schematic diagram of a tenth application of the information processing method according to some embodiments. In FIG. 5E, in response to a trigger operation on the entry 228 to the third page corresponding to the information category 225, the first subpage 210, the second subpage 218, the second page 221, and a third page 229 corresponding to the first information category 225 are displayed on the same screen, and the stock quantity 11 of pieces of unread information corresponding to the first information category on the third page is set to zero. The third page 229 further includes an entry 230 for returning to the second page. In response to a trigger operation on the entry 230 for returning to the second page, the first subpage, the second subpage, the second page, and the third page shown in FIG. 5E are switched to the first subpage, the second subpage, and the second page shown in FIG. 5F for displaying.

As an example of the foregoing embodiment, referring to FIG. 5F, FIG. 5F is a schematic diagram of an eleventh application of the information processing method according to some embodiments. In FIG. 5F, the first subpage 210, the second subpage 218, and the second page 221 are displayed on the same screen. On the second subpage 218, the incremental quantity of pieces of unread information included in the entry 219 to the second page is updated to 1. On the first subpage 210, the incremental quantity of pieces of unread information included in the circular icon 216 behind the function item 212 on the first subpage 210 is updated to 1.

According to some embodiments, a plurality of pages are displayed in a split-screen mode, so that a change in quantity on each page in different cases can be reflected more clearly, improving visibility and intuitiveness of the change in quantity.

According to some embodiments, only an increment of unread information received after the second page is entered is displayed on the first page, and stocks of unread information of all the information categories are displayed on the second page, so that quantities of pieces of unread information of different types are displayed on different pages. After the second page is displayed, if new information is received, the incremental quantity of pieces of unread information on the first page is updated, to indicate a quantity of pieces of new information received after the second page is displayed, avoid continuous accumulation of the quantity of pieces of unread information on the first page, and achieve higher operational efficiency than a manner of manually viewing information to update the incremental quantity of pieces of unread information on the first page; and the stock quantities of pieces of unread information on the second page are updated, to indicate current quantities of pieces of unread information accumulated in different information categories to the user, so that the user can conveniently learn comparison between the quantities of pieces of unread information before and after the second page is displayed, improving user experience.

In some embodiments, referring to FIG. 3F, FIG. 3F is a sixth schematic flowchart of the information processing method according to some embodiments. Before the "updating the incremental quantity of pieces of unread information to a second quantity of pieces of information" in the foregoing embodiment, operation 501 to operation 503 in FIG. 3F may be further performed. Details are described below.

Operation 501: Transmit a first time stamp to the server corresponding to the client, to trigger the server to generate a plurality of first count values, the first time stamp being a moment at which the second page starts to be displayed, and the plurality of first count values respectively representing quantities of pieces of unread information of the plurality of information categories at the moment corresponding to the first time stamp.

For example, when the second page is displayed, a quantity of pieces of unread information of the information category "comments" is 3, and a quantity of pieces of unread information of the information category "likes" is 2. In this case, the plurality of first count values are 3 and 2.

Operation 502: Transmit a second time stamp to the server, to trigger the server to generate a plurality of second count values, determine a sub-incremental quantity of pieces of unread information of each information category based on the second count value and the first count value that correspond to each information category, and determine a sum of the plurality of sub-incremental quantities of pieces of unread information respectively corresponding to the plurality of information categories as the second quantity of pieces of information, the second time stamp representing a moment at which the new information of the at least one information category is received, and the plurality of second count values respectively representing quantities of pieces of unread information of the plurality of information categories at the moment corresponding to the second time stamp.

For example, after the second page is displayed, if a quantity of pieces of received new information of the information category "comments" is 1, for example, each of a plurality of incremental quantities of pieces of unread information corresponding to the information category "comments" is 1, and a quantity of pieces of received new information of the information category "likes" is 4, for example, each of a plurality of incremental quantities of pieces of unread information corresponding to the information category "likes" is 3, it is determined that a sum of the incremental quantities of pieces of unread information corresponding to the information category "comments" is 3, for example, a quantity of pieces of unread information of the information category "comments" at the second time stamp is 3, and it is determined that a sum of the incremental quantities of pieces of unread information corresponding to the information category "likes" is 6, for example, a number of pieces of unread information corresponding to the information category "likes" is 6. In this case, the plurality of second count values are 3 and 6.

In some embodiments, the first time stamp ensures that when the second page is viewed, current quantities of pieces of unread information respectively corresponding to the plurality of information categories can be immediately obtained, providing real-time information presentation, ensuring that page information keeps consistent with a status of the server, and reducing a delay from a request of the client to a response of the server. The client only may transmit the first time stamp when the second page is displayed, and does not need complex logic to record a change of the unread information. The second time stamp allows the server to dynamically update, when new information is received, the quantities of pieces of unread information respectively corresponding to the plurality of information categories, ensuring timeliness of the information. The second count values are compared with the first count values, so that the sub-incremental quantities of pieces of unread information of the information categories can be accurately calculated, reducing unnecessary full calculation. Count update is performed only when new information arrives, so that frequent full requests are avoided, use of server resources is optimized, accuracy of the quantity of pieces of unread information is ensured, and errors caused by information omission are avoided.

In some embodiments, the counter runs in the server, the counter includes the plurality of sub-counters, the server is configured to separately count the unread information of the plurality of information categories via the plurality of sub-counters, to obtain the plurality of first count values and the plurality of second count values, and the plurality of first count values are recorded in snapshot data of the counter.

In some embodiments, the plurality of sub-counters include a plurality of sub-version numbers respectively corresponding to the plurality of information categories. When there are a plurality of pieces of new information of the at least one information category, all the new information is used as unread information. Referring to FIG. 3G, FIG. 3G is a seventh schematic flowchart of the information processing method according to some embodiments. A manner in which the server "separately counts the unread information of the plurality of information categories via the plurality of sub-counters" may be implemented by performing operation 601 and operation 602 in FIG. 3G. Details are described below.

Operation 601: Update, in response to receiving first information of a fourth information category, a sub-version number of a sub-counter corresponding to the fourth information category to a first sub-version number, and add 1 to a first count value corresponding to the fourth information category, to obtain a second count value corresponding to the fourth information category, the fourth information category being any one of the plurality of information categories, and the first information being any piece of new information of the fourth information category.

For example, the sub-version number of the sub-counter corresponding to the fourth information category before the first information of the fourth information category is received is 1, and a quantity of pieces of first information of the fourth information category, for example, the first count value, is 1. In this case, in response to receiving the first information of the fourth information category, the sub-version number 1 of the sub-counter corresponding to the fourth information category is updated to the first sub-version number 2, and 1 is added to the first count value 1 corresponding to the fourth information category, to obtain the second count value 2 corresponding to the fourth information category.

Operation 602: Update the first sub-version number to a second sub-version number in response to receiving second information of the fourth information category between the moment corresponding to the second time stamp and a moment corresponding to a third time stamp, and add 1 to the second count value corresponding to the fourth information category, to obtain a third count value corresponding to the fourth information category, the third time stamp representing a moment at which the second count value corresponding to the fourth information category is generated, the second information being a next piece of new information received after the first information, and the third count value representing a quantity of pieces of new information of the fourth information category at the moment corresponding to the third time stamp.

For example, after the first information of the fourth information category is received, and before the second count value corresponding to the fourth information category is generated, the second information of the fourth information category is received. In this case, the first sub-version number 2 is updated to the second sub-version number 3, and 1 is added to the second count value 2 corresponding to the fourth information category, to obtain the third count value 3 corresponding to the fourth information category.

In some embodiments, when there are a plurality of pieces of new information of the at least one information category, a sub-version number and a count value that correspond to the second information start to be updated when update of a sub-version number and a count value that correspond to the first information is completed. In this way, when the plurality of pieces of new information enter, each piece of new information may be updated in sequence based on a sub-version number and a count value that correspond to a previous piece of new information. This avoids an update conflict between sub-version numbers and count values caused by simultaneous update of a large amount of new information, and improves update orderliness.

In some embodiments, referring to FIG. 3H, FIG. 3H is an eighth schematic flowchart of the information processing method according to some embodiments. A manner in which the server implements "determining of the sub-incremental quantity of pieces of unread information of each information category" in operation 602 in FIG. 3G may be implemented by performing operation 6021 and operation 6022 in FIG. 3H for each of the plurality of the plurality of information categories. Details are described below.

Operation 6021: Determine a difference between the second count value corresponding to the information category and the first count value corresponding to the information category in the snapshot data as the sub-incremental quantity of pieces of unread information of the information category in response to a quantity of pieces of unread information of the information category being not zero.

In some embodiments, the snapshot data is data recorded by the counter running in the server corresponding to the client when the second page is displayed. The snapshot data includes the quantities (for example, the first count values) of pieces of unread information of the plurality of information categories at the moment (for example, the first time stamp) at which the second page is displayed.

For example, in response to the quantity of pieces of unread information of the information category being not zero, if a second count value corresponding to the information category "comments" is 4, and a first count value corresponding to the information category "comments" is 3, the sub-incremental quantity of pieces of unread information of the information category is 1.

Operation 6022: Delete the first count value corresponding to the information category from the snapshot data in response to the quantity of pieces of unread information of the information category being zero, and use the second count value corresponding to the information category as the sub-incremental quantity of pieces of unread information of the information category.

For example, in response to the quantity of pieces of unread information of the information category being zero, for example, in response to all the unread information changing to the read state, if a first count value corresponding to the information category "comment" is 3, and a second count value corresponding to the information category "comments" is 4, the first count value 3 corresponding to the information category "comments" is deleted from the snapshot data, and the sub-incremental quantity of pieces of unread information corresponding to the information category "comments" is 4.

Still referring to FIG. 3F, in operation 503, the second quantity of pieces of information transmitted by the server is received.

In some embodiments, the quantities of pieces of unread information of the plurality of information categories when the second page is entered are recorded by using the snapshot data, to calculate the stock quantity of pieces of unread information and the incremental quantity of pieces of unread information after the second page is displayed and when new information is received. When the second page is entered next time, a previous piece of snapshot data is deleted. This improves calculation efficiency, and reduces occupation of cache space.

In some embodiments, the client includes a first information sequence number, and an initial value of the first information sequence number is the same as an initial value of a second information sequence number on the server. For example, the initial values are both 0. After the "new information of the at least one information category is received after the second page is displayed" in operation 103 in FIG. 3A, the following operation may be further performed: transmitting a query request to the server, to trigger the server to query the second information sequence number, the server updating the second information sequence number based on a quantity of pieces of new information of the at least one information category when transmitting the new information of the at least one information category to the client, and the second information sequence number representing the quantity of pieces of new information of the at least one information category received by the server.

For example, if the initial value of the first information sequence number on the client and the initial value of the second information sequence number on the server are both 0, when the server transmits the new information of the at least one information category to the client, for example, the quantity of pieces of new information of the information category "likes" is 2, and the quantity of pieces of new information of the information category "comments" is 1, the quantity of pieces of new information of the at least one information category is 3, and the second information sequence number is updated from the initial value 0 to 3.

In some embodiments, after the "updating the incremental quantity of pieces of unread information" in operation 103 in FIG. 3A, the following operation may be further performed: updating the first information sequence number based on the quantity of pieces of new information of the at least one information category, an updated first information sequence number being the same as an updated second information sequence number.

Still in the foregoing example, when the incremental quantity of pieces of unread information is updated, if the quantity of pieces of new information of the at least one information category is 3, the second information sequence number is 3, and the first information sequence number is updated from the initial value 0 to 3. In this case, both the updated first information sequence number and the updated second information sequence number are 3.

In some embodiments, when transmitting the new information of the at least one information category to the client, the server updates the second information sequence number based on the quantity of pieces of new information of the at least one information category, and updates the first information sequence number after updating the incremental quantity of pieces of unread information, so that the client synchronously updates the first information sequence number after the server updates the first information sequence number. In this way, the client and the server complete quantity update in a case in which the information sequence numbers are consistent, avoiding repeated quantity update.

In some embodiments, the second page further includes the entry to the first page. After the "updating the incremental quantity of pieces of unread information" in operation 103 in FIG. 3A, the following operation may be further performed: displaying, based on the cached page data of the first page in response to a trigger operation on the entry to the first page, the first page on which the page refresh has been performed, the incremental quantity of pieces of unread information on the first page being the second quantity of pieces of information.

In some embodiments, if the first page includes the plurality of levels of subpages, the second page includes an entry to the last level of subpage, and the last level of subpage on which the page refresh has been performed is displayed based on the cached page data of the first page in response to a trigger operation on the entry to the last level of subpage, the incremental quantity of pieces of unread information on the last level of subpage being the second quantity of pieces of information. In addition, the second subpage includes an entry for returning to a previous level of subpage (for example, the first subpage), and the previous level of subpage on which the page refresh has been performed is displayed based on the cached page data of the first page in response to a trigger operation on the entry to the previous level of subpage, the incremental quantity of pieces of unread information on the previous level of subpage being also the second quantity of pieces of information.

For example, two levels of subpages are used as an example. The second page further includes an entry to a second level of subpage, and the second level of subpage on which the page refresh has been performed is displayed based on the cached page data of the first page in response to a trigger operation on the entry to the second level of subpage, the incremental quantity of pieces of unread information on the second level of subpage being the second quantity of pieces of information. In addition, the second level of subpage includes an entry to a first level of subpage, and the first level of subpage on which the page refresh has been performed is displayed based on the cached page data of the first page in response to a trigger operation on the entry to the first level of subpage, the incremental quantity of pieces of unread information on the first level of subpage being also the second quantity of pieces of information.

As an example, referring to FIG. 4E, in response to a trigger operation on the entry 222 to the first page in the left figure of FIG. 4E, in the middle figure of FIG. 4E, the incremental quantity of pieces of unread information in the entry 219 to the second page on the second level of subpage 218 is updated to the second quantity 1 of pieces of information based on the cached page data of the first page. In response to a trigger operation on the entry 220 to the first level of subpage, in the right figure of FIG. 4E, the incremental quantity of pieces of unread information in the function item 212 on the first level of subpage 210 is updated to the second quantity 1 of pieces of information based on the cached page data of the first page.

According to some embodiments, the entry of the first page included on the second page allows quick returning to the first page, enhancing convenience in navigation. In addition, the page refresh is performed by using the cached page data, so that loading time can be reduced, network traffic can be reduced, and a system response speed and efficiency can be improved. During returning to or refreshing page, the incremental quantity of pieces of unread information is updated to the second quantity of pieces of information, so that it is ensured that the user sees the latest unread information status, and the real-time performance of the information is improved. The user only may click the entry to return to or access the subpage, and the incremental quantity of pieces of unread information is automatically updated, so that the operation procedure is simplified, and convenience in operation is improved. For any level of subpage, during returning to a previous level of subpage, the incremental quantity of pieces of unread information is kept consistent, so that the consistency and the accuracy of the information are ensured.

### The following describes an exemplary application of some embodiments to an actual application scenario.

A short video information notification in instant messaging software is used as an example. When receiving notifications of a plurality of information categories, the client may display a quantity of pieces of unread information on a page. In a related technology, the user usually may click each piece of unread information in sequence, the quantity of pieces of unread information displayed on the page can be reduced only after message content is displayed, and only a total quantity of pieces of unread information is displayed on the page. Consequently, an interaction path is excessively long, a process of reducing the quantity of pieces of unread information is complex, and excessive accumulation of unread information affects user experience. According to the information processing method provided in some embodiments, different quantities of pieces of unread information are displayed on different pages, so that only the increment of the unread information received after the second page is entered is displayed on the first page, and the stocks of the unread information of all the information categories are displayed on the second page. In this way, after triggering the second page, the user can set the quantity of pieces of unread information on the first page to zero, and after new information is received, only a quantity of pieces of new information is displayed on the first page.

Referring to FIG. 6, FIG. 6 is a schematic diagram of a principle of unidirectional control in a related technology according to some embodiments. In the related technology, a unidirectional control solution is usually used, for example, after the server delivers a dynamic configuration or an experiment platform delivers a configuration, the client reads a switch (for example, a configuration variable, configured for dynamically enabling or disabling some functions, without releasing an entire application again), for example, whether an experiment is hit. In the unidirectional control solution, the server transmits the switch to the client, and the client does not return the switch to the server. The experiment is an A/B experiment. For example, when a function may be online, it may be controlled through an experiment that one part of users use the function and the other part of users do not use the function. Hitting of the experiment may be divided into a plurality of circles based on region distribution, age distribution, or gender difference. A hitting method is random distribution hitting. Hitting the experiment means that the user implements an incremental red dot solution (for example, the information processing method).

Referring to FIG. 7, FIG. 7 is a schematic diagram of a principle of a solution for delivering an incremental red dot according to some embodiments. In a process of implementing the incremental red dot solution, both the client and the server need to detect whether the experiment is hit. In other words, the server delivers an incremental red dot (for example, an interactive notification) only after hitting the experiment, and the client uses an incremental red dot accumulation solution (for example, the information processing method) only after hitting the experiment. Therefore, a technical solution of a client-server linked experiment is used. In FIG. 7, a finder is initialized to read an experimental result. The switch is delivered by the server to the client in a form of a buffer. After receiving the buffer, the client parses the switch in the form of the buffer based on a requirement, and transmits the buffer to the server when triggering a network request (for example, a query request), to implement linkage between the client and the server. For example, when a switch may be sensed by both the server and the client, the client presents an entry for selecting a red dot after sensing the switch; and after the server senses the switch, if the server is intended to deliver a red dot, the server may read a red dot switch. In this case, the server and the client need to be linked to sense the switch. The buffer is data in a binary form. The buffer may be defined as data of a dictionary type, for example, a key-value type. Therefore, after obtaining the buffer, the client may parse the buffer by using a structured data storage format (Protocol Buffers, ProtocolBuf), to obtain a data structure similar to the following: Key_1-value _ xxx, where value may be 0, indicating that the experiment is not hit and an original counting solution is used; or value may be 1, indicating that the experiment is hit and the incremental red dot solution is used.

### The incremental red dot solution is specifically as follows.

First, the client starts, the server transmits the switch in the form of the buffer to the client, and the client reads and parses the received switch.

Then, if the switch represents that the client hits the experiment, when a new message enters, a red dot quantity A delivered by the server and a red dot quantity B of a local function of the client are accumulated, and a red dot quantity A+B is presented on a personal information page of the instant messaging software of the client.

Next, when the user clicks to enter a specified interface (for example, the second page), the client notifies the server that the user enters the page. After receiving the notification, the server records a time stamp TimeStamp_1 (for example, the first time stamp). If a current time stamp is TimeStamp_2 (for example, the second time stamp), when the server delivers a red dot again, the server delivers only a new red dot A' within a time period from TimeStamp_1 to TimeStamp_2.

Finally, the red dot A' delivered by the server and the red dot B of the local function of the client are accumulated, a red dot quantity presented on the personal page (for example, the second page) is A'+B, and a red dot quantity presented on an outer layer (for example, the first page) is A'.

Similarly, when the user clicks to enter the specified interface (for example, the second page), the client notifies the server that the user enters the page. After receiving the notification, the server records a time stamp TimeStamp_3. If the current time stamp is TimeStamp_4, when the server delivers a red dot again, the server delivers only a new red dot A'' within a time period from TimeStamp_3 to TimeStamp_4. The red dot A'' delivered by the server and the red dot B of the local function of the client are accumulated, a red dot quantity presented on the personal page (for example, the second page) is A''+B, and a red dot quantity presented on the outer layer (for example, the first page) is A''.

If the incremental red dot solution is not hit in the buffer, logic that all red dots are accumulated is maintained.

According to the incremental red dot solution, the server calculates a quantity of pieces of new information received after the specified interface, only the quantity of pieces of new information (for example, the incremental quantity of pieces of unread information) is displayed on the outer layer, and a sum (for example, a stock quantity of pieces of unread information) of a quantity of pieces of unread information before the personal page is entered and the quantity of pieces of new information (for example, the inventory quantity of unread information) is displayed on the personal page, so that quantities of pieces of unread information of different types are displayed on different pages, avoiding continuous accumulation of the quantity of pieces of unread information on the outer layer. Compared with a manner of manually viewing information to update the quantity of pieces of unread information on the outer layer, this has higher operational efficiency. In addition, the server calculates only a quantity of pieces of new information delivered after the specified page is displayed, so that efficiency of updating the quantity of pieces of unread information is improved.

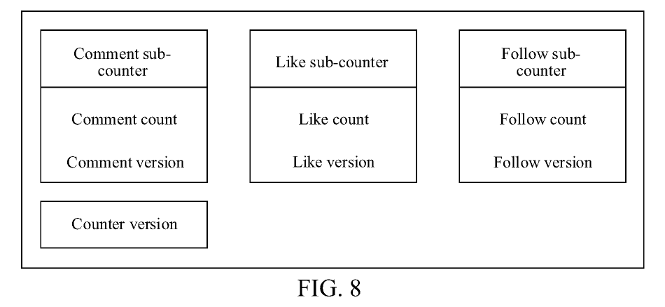

Referring to FIG. 8, FIG. 8 is a diagram of a structure of the counter according to some embodiments. The server maintains a global distributed counter to record quantities of unread messages of three types (for example, information categories): "comments", "likes", and "follows". Each time there is a new message, a counting operation is performed on a sub-counter corresponding to a type of the message. When digits are delivered, information of the entire counter is pulled, and corresponding digits of unread information are delivered.

A deduplication operation may be performed when the digits are delivered, including the following two manners.

Manner 1: A message sequence number is used for deduplication: Each user has an independent message sequence number, and in an initial state, message sequence numbers of the user on the client and the server are the same. When a new message arrives, the message sequence number (for example, the second information sequence number) on the server increases. In this case, the client requests the server again. The server finds, by checking the message sequence number, that the message sequence number (for example, the first information sequence number) on the client is less than the message sequence number on the server, and attempts to pull the counter and deliver the digit. If the delivery succeeds, the message sequence number on the server is synchronously updated to the client, the message sequence numbers at both sides become consistent, and no digital red dot is not repeatedly delivered subsequently.

Manner 2: A manner of emptying the counter is used for deduplication fallback: When the user clicks a message page (for example, the third page) of the personal center, it is considered that the user has finally read the message. In this case, the client notifies the server to empty the entire counter in time. If newly added information (for example, new information) is received at the same time, the newly added information is cleared together. If a newly added message is received after the message page is entered for a period of time, only original unread information (for example, the stock quantity of pieces of unread information) is cleared, and the newly added message is still displayed. This ensures that the digit is not repeatedly delivered during cross-device pulling or resetting of the client.

When the user clicks the personal center, the client reports a click behavior to the server, and the server writes snapshot data of the counter. The snapshot data is a complete backup of the counter, and all information in the snapshot data is completely consistent with the original counter during backup. When the digital red point may be delivered, counter data and the snapshot data of the counter are obtained, differences between comments, likes, and follows of the counter data and the snapshot data of the counter are calculated, and an outer-layer digital red dot is delivered to the client based on the differences.

Counter update consistency: Each counter has its own version number, and each time the counter is updated (for example, when a new message enters, or a historical message is read), the version number of the counter is incremented by 1. When data of the counter is updated, whether an obtained version number of the counter is consistent with a version number of a latest current counter may be verified, and the data is updated only when the obtained version number of the counter is consistent with the version number of the latest current counter, ensuring the data update consistency. For example, two different messages are received almost at the same time. If an original quantity of messages in the counter is 1, and the version number is 100, after the first message enters, update is performed based on the counter of the version number 100, to obtain a counter of a version number 101 in which a quantity of messages is 2. For the second message, update is also performed based on the version number 100. However, the latest version number is 101 at this point, and the obtained version number 100 is inconsistent with the latest version number 101. Therefore, only the first message is retained. After update for the first message is completed, for example, after the version number changes to 101, the counter of the version number 101 is updated for the second message to obtain a counter of a version number 102 in which a quantity of messages is 3.

Data consistency between the data of the counter and the snapshot data of the counter: A sub-counter version (for example, a sub-version number) is recorded in the sub-counter, to mark validity of the snapshot data. When the user has finally read a message of a type (for example, any information category), a sub-counter version is updated while the sub-counter is emptied, so that version of the child counter is updated while the child counter is emptied, so that a sub-counter version in the snapshot data of the counter is less than the sub-counter version, to invalidate a snapshot of the sub-counter and delete the snapshot data without updating the snapshot data. Information of the category "comments" is used as an example. When the comment digit is finally read, for example, when a comment tab of a message list (for example, the second page) of the personal center is clicked, a comment version of a comment sub-counter is updated to the version of the counter while a comment count of the comment sub-counter is cleared, so that the comment version in the comment sub-counter is inconsistent with a comment version in the snapshot of the counter. When the outer-layer digit is subsequently delivered, no more reference is made to the comment count in the snapshot of the counter when the comment count is calculated.

In the related technology, the digital red dot is usually delivered completely depending on the server. However, from the perspective of scalability, the incremental red dot solution of some embodiments is compatible with red dot delivery by the server and red dot construction by the client.

After hitting the experiment, the client combines the digital red point (for example, the incremental quantity of pieces of unread information) delivered by the server and the digital red point (for example, the stock quantity of pieces of unread information) locally constructed by the client. A method for calculating the local digital red point of the client uses a dotting solution, for example, only point-to-point messages (for example, the new information) after TimeStamp1 (for example, the first time stamp) are summed, and a point-to-point message before the time stamp TimeStamp1 is used as a "read message".

From the perspective of a function of the digital red dot, the digital red dot in the related technology is eliminated dependently, for example, the digital red dot can be eliminated only when a deepest function entry (for example, the third page) is clicked. However, in the incremental red dot solution, only a prompt function of the digital red dot is used, avoiding a case in which the red dot is kept displayed because an elimination path of the red dot is excessively long for the user. The red dot is implemented in cooperation of a dependent mode and an independent mode. Before a function presentation of a last level of page (for example, the second page), for example, at a place where the first page is presented, the digital red dot is dependent, and once the last level of page continues to be exposed, a previous red dot is eliminated, to achieve an intention of reducing interference to the user while prompting the user. In addition to accumulative presentation, the client may present each newly added red dot in the personal center in a +x manner according to the following two solutions.

Solution 1: If there is one new message on a page (for example, a first page) of a video account, and +1 is displayed behind a corresponding bar, indicating a quantity of red dot messages newly added this time (for example, an incremental quantity of pieces of unread information).

Solution 2: If there is one new message for a video account, +1 is displayed behind an existing message red dot on a personal page (for example, a third page), indicating a quantity of red dot messages newly added this time.

According to some embodiments, only an increment of unread information received after the second page is entered is displayed on the first page, and stocks of unread information of all the information categories are displayed on the second page, so that quantities of pieces of unread information of different types are displayed on different pages. After the second page is displayed, if new information is received, the incremental quantity of pieces of unread information on the first page is updated, to indicate a quantity of pieces of new information received after the second page is displayed, avoid continuous accumulation of the quantity of pieces of unread information on the first page, and achieve higher operational efficiency than a manner of manually viewing information to update the incremental quantity of pieces of unread information on the first page; and the stock quantities of pieces of unread information on the second page are updated, to indicate current quantities of pieces of unread information accumulated in different information categories to the user, so that the user can conveniently learn comparison between the quantities of pieces of unread information before and after the second page is displayed, improving user experience. A plurality of pages are displayed in the split-screen mode, so that a change in quantity on each page in different cases can be reflected more clearly, improving visibility and intuitiveness of the change in quantity. The quantities of pieces of unread information of the plurality of information categories when the second page is entered are recorded by using the snapshot data, to calculate the stock quantity of pieces of unread information and the incremental quantity of pieces of unread information after the second page is displayed and when new information is received. When the second page is entered next time, a previous piece of snapshot data is deleted. This improves calculation efficiency, and reduces occupation of cache space. When there are a plurality of pieces of new information of the at least one information category, a sub-version number and a count value that correspond to the second information start to be updated when update of a sub-version number and a count value that correspond to the first information is completed. In this way, when the plurality of pieces of new information enter, each piece of new information may be updated in sequence based on a sub-version number and a count value that correspond to a previous piece of new information. This avoids an update conflict between sub-version numbers and count values caused by simultaneous update of a large amount of new information, and improves update orderliness. When transmitting the new information of the at least one information category to the client, the server updates the second information sequence number based on the quantity of pieces of new information of the at least one information category, and updates the first information sequence number after updating the incremental quantity of pieces of unread information, so that the client synchronously updates the first information sequence number after the server updates the first information sequence number. In this way, the client and the server complete quantity update in a case in which the information sequence numbers are consistent, avoiding repeated quantity update.

The following continues to describe an exemplary structure in which the information processing apparatus map 455 provided in some embodiments is implemented as a software module. In some embodiments, as shown in FIG. 2, the software module in the information processing apparatus 455 stored in the memory 450 may include:

a first display module 4551, configured to display a first page of a client, the first page including an entry to a second page and an incremental quantity of pieces of unread information, and the incremental quantity of pieces of unread information being a total quantity of pieces of unread information received after the second page is displayed last time;

a second display module 4552, configured to display the second page in response to a trigger operation on the entry to the second page, the second page including a plurality of information categories and stock quantities of pieces of unread information respectively corresponding to the plurality of information categories, and the stock quantities of pieces of unread information being quantities of pieces of unread information accumulated in the information categories; and

a quantity update module 4553, configured to update, based on new information of at least one information category in response to receiving the new information of the at least one information category after the second page is displayed, a stock quantity of pieces of unread information corresponding to the at least one information category, and update the incremental quantity of pieces of unread information.

In some embodiments, the first page includes a plurality of levels of subpages having a level-by-level jump relationship. The first display module 4551 is further configured to: display a first subpage in the plurality of levels of subpages, the first subpage including an entry to a second subpage, the first subpage being any level of subpage other than a last level of subpage in the plurality of levels of subpages, and the second subpage being a next level of subpage of the first subpage; and display the second subpage in response to a trigger operation on the entry to the second subpage on the first subpage, the second subpage including an entry to a next level of subpage of the second subpage when the second subpage is not the last level of subpage, and the second subpage including the entry to the second page when the second subpage is the last level of subpage.

In some embodiments, the quantity update module 4553 is further configured to update, for each of the plurality of information categories, the stock quantity of pieces of unread information corresponding to the information category to a first quantity of pieces of information, the first quantity of pieces of information being a sum of the stock quantity of pieces of unread information corresponding to the information category and a quantity of pieces of new information of the information category.

In some embodiments, the quantity update module 4553 is further configured to update the incremental quantity of pieces of unread information to a second quantity of pieces of information, the second quantity of pieces of information being a total quantity of pieces of new information of the at least one information category.

In some embodiments, when the client is in a split-screen display mode, the first page and the second page are both in a displayed state. The quantity update module 4553 is further configured to update the incremental quantity of pieces of unread information displayed on the first page to the second quantity of pieces of information in response to the client being in the split-screen display mode.

In some embodiments, when the client is in a single-screen display mode, and the second page is in a displayed state, the first page is in a hidden state. The quantity update module 4553 is further configured to update the incremental quantity of pieces of unread information in cached page data of the first page to the second quantity of pieces of information in response to the client being in the single-screen display mode, the cached page data of the first page being configured for performing page refresh when the first page is switched to a displayed state.

In some embodiments, the quantity update module 4553 is further configured to: transmit a first time stamp to a server corresponding to the client, to trigger the server to generate a plurality of first count values, the first time stamp being a moment at which the second page starts to be displayed, and the plurality of first count values respectively representing quantities of pieces of unread information of the plurality of information categories at the moment corresponding to the first time stamp; transmit a second time stamp to the server, to trigger the server to generate a plurality of second count values, determine a sub-incremental quantity of pieces of unread information of each information category based on the second count value and the first count value that correspond to each information category, and determine a sum of the plurality of sub-incremental quantities of pieces of unread information respectively corresponding to the plurality of information categories as the second quantity of pieces of information, the second time stamp representing a moment at which the new information of the at least one information category is received, and the plurality of second count values respectively representing quantities of pieces of unread information of the plurality of information categories at the moment corresponding to the second time stamp; and receive the second quantity of pieces of information transmitted by the server.

In some embodiments, a plurality of sub-counters include a plurality of sub-version numbers respectively corresponding to the plurality of information categories. When there are a plurality of pieces of new information of the at least one information category, all the new information is used as unread information, and the quantity update module 4553 is further configured to: update, in response to receiving first information of a fourth information category, a sub-version number of a sub-counter corresponding to the fourth information category to a first sub-version number, and add 1 to a first count value corresponding to the fourth information category, to obtain a second count value corresponding to the fourth information category, the fourth information category being any one of the plurality of information categories, and the first information being any piece of new information of the fourth information category; and update the first sub-version number to a second sub-version number in response to receiving second information of the fourth information category between the moment corresponding to the second time stamp and a moment corresponding to a third time stamp, and add 1 to the second count value corresponding to the fourth information category, to obtain a third count value corresponding to the fourth information category, the third time stamp representing a moment at which the second count value corresponding to the fourth information category is generated, the second information being a next piece of new information received after the first information, and the third count value representing a quantity of pieces of new information of the fourth information category at the moment corresponding to the third time stamp.

In some embodiments, the quantity update module 4553 is further configured to perform the following operations for each of the plurality of information categories: determining a difference between the second count value corresponding to the information category and the first count value corresponding to the information category in snapshot data as the sub-incremental quantity of pieces of unread information of the information category in response to a quantity of pieces of unread information of the information category being not zero; and deleting the first count value corresponding to the information category from snapshot data in response to the quantity of pieces of unread information of the information category being zero, and using the second count value corresponding to the information category as the sub-incremental quantity of pieces of unread information of the information category.

In some embodiments, the second page further includes entries to third pages respectively corresponding to the plurality of information categories. The second display module 4552 is further configured to display, in response to a trigger operation on an entry to a third page corresponding to a first information category, the third page corresponding to the first information category, and set a stock quantity of pieces of unread information corresponding to the first information category on the third page to zero, the first information category being any one of the plurality of information categories.

In some embodiments, the second display module 4552 is further configured to: in response to receiving new information of the first information category after the third page is displayed, set the stock quantity of pieces of unread information corresponding to the first information category on the second page to zero if a difference between a moment at which the new information of the first information category is received and a moment at which all unread information on the third page is in a read state is less than a time threshold, and keep the incremental quantity of pieces of unread information on the first page unchanged; and update, based on the new information of the first information category if the difference between the moment at which the new information of the first information category is received and the moment at which all the unread information on the third page is in the read state is greater than or equal to the time threshold, the stock quantity of pieces of unread information corresponding to the first information category, and update the incremental quantity of pieces of unread information.

In some embodiments, the server corresponding to the client includes a counter, the counter includes the plurality of sub-counters, and the plurality of sub-counters are configured to respectively count the unread information of the plurality of information categories. The second display module 4552 is further configured to transmit, to the server, a notification that unread information on the third page is in a read state, to trigger the server to perform the following processing: setting the stock quantity of pieces of unread information in a sub-counter corresponding to the first information category to zero in response to the unread information on the third page being all in the read state and a difference between a moment at which the unread information is all in the read state and a moment at which new information of the first information category is received being less than or equal to a time threshold, and deleting a quantity of pieces of new information of the first information category; and setting the stock quantity of pieces of unread information in the sub-counter corresponding to the first information category to zero in response to the unread information on the third page being all in the read state and the difference between the moment at which the unread information is in the read state and the moment at which new information of the first information category is received being greater than the time threshold, and displaying the quantity of pieces of new information of the first information category on the second page.

In some embodiments, the second page further includes entries to third pages respectively corresponding to the plurality of information categories. The second display module 4552 is further configured to: display, in response to a trigger operation on an entry to a third page corresponding to a second information category, the third page corresponding to the second information category, the second information category being any one of the plurality of information categories; and display, in response to a trigger operation on at least one piece of unread information on the third page, the triggered unread information on the third page, and update a stock quantity of pieces of unread information corresponding to the second information category to a third quantity of pieces of information, the third quantity of pieces of information being a difference between the stock quantity of pieces of unread information corresponding to the second information category and a quantity of pieces of triggered new information on the third page.

In some embodiments, the client includes a first information sequence number, and an initial value of the first information sequence number is the same as an initial value of a second information sequence number on the server. The quantity update module 4553 is further configured to transmit a query request to the server, to trigger the server to query the second information sequence number, the server updating the second information sequence number based on a quantity of pieces of new information of the at least one information category when transmitting the new information of the at least one information category to the client, and the second information sequence number representing the quantity of pieces of new information of the at least one information category received by the server.

In some embodiments, the quantity update module 4553 is further configured to update the first information sequence number based on the quantity of pieces of new information of the at least one information category, an updated first information sequence number being the same as an updated second information sequence number.

In some embodiments, the second page further includes an entry to the first page. The quantity update module 4553 is further configured to display, based on cached page data of the first page in response to a trigger operation on the entry to the first page, the first page on which the page refresh has been performed, the incremental quantity of pieces of unread information on the first page being the second quantity of pieces of information.

Some embodiments provides a computer program product. The computer program product includes a computer program or computer-executable instructions. The computer program or the computer-executable instructions are stored in a computer-readable storage medium. A processor of an electronic device reads the computer-executable instructions from the computer-readable storage medium. The processor executes the computer-executable instructions, so that the electronic device performs the information processing method according to some embodiments.

Some embodiments provides a computer-readable storage medium having computer-executable instructions stored therein, which has the computer-executable instructions or a computer program stored therein. The computer-executable instructions or the computer program, when executed by a processor, causes the processor to perform the information processing method provided in some embodiments, for example, the information processing method shown in FIG. 3A.

In some embodiments, the computer-readable storage medium may be a memory such as a RAM, a ROM, a flash memory, a magnetic surface memory, an optical disk, or a CD-ROM; or may be various devices including one or any combination of the foregoing memories.

In some embodiments, the computer-executable instructions may be written in any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit suitable for use in a computing environment.

In an example, the computer-executable instruction may but may not necessarily correspond to a file in a file system, and may be stored in a part of the file for storing other programs or data, for example, stored in one or more scripts in a hypertext markup language (HTML) document, stored in a single file specially for the discussed program, or stored in a plurality of collaborative files (for example, files storing one or more modules, a subprogram, or a code part).

In an example, the computer-executable instructions may be deployed to be executed on one electronic device, on a plurality of electronic devices located at one site, or on a plurality of electronic devices distributed at a plurality of locations and connected to each other by a communication network.

In conclusion, according to some embodiments, only an increment of unread information received after the second page is entered is displayed on the first page, and stocks of unread information of all the information categories are displayed on the second page, so that quantities of pieces of unread information of different types are displayed on different pages. After the second page is displayed, if new information is received, the incremental quantity of pieces of unread information on the first page is updated, to indicate a quantity of pieces of new information received after the second page is displayed, avoid continuous accumulation of the quantity of pieces of unread information on the first page, and achieve higher operational efficiency than a manner of manually viewing information to update the incremental quantity of pieces of unread information on the first page; and the stock quantities of pieces of unread information on the second page are updated, to indicate current quantities of pieces of unread information accumulated in different information categories to the user, so that the user can conveniently learn comparison between the quantities of pieces of unread information before and after the second page is displayed, improving user experience. A plurality of pages are displayed in the split-screen mode, so that a change in quantity on each page in different cases can be reflected more clearly, improving visibility and intuitiveness of the change in quantity. The quantities of pieces of unread information of the plurality of information categories when the second page is entered are recorded by using the snapshot data, to calculate the stock quantity of pieces of unread information and the incremental quantity of pieces of unread information after the second page is displayed and when new information is received. When the second page is entered next time, a previous piece of snapshot data is deleted. This improves calculation efficiency, and reduces occupation of cache space. When there are a plurality of pieces of new information of the at least one information category, a sub-version number and a count value that correspond to the second information start to be updated when update of a sub-version number and a count value that correspond to the first information is completed. In this way, when the plurality of pieces of new information enter, each piece of new information may be updated in sequence based on a sub-version number and a count value that correspond to a previous piece of new information. This avoids an update conflict between sub-version numbers and count values caused by simultaneous update of a large amount of new information, and improves update orderliness. When transmitting the new information of the at least one information category to the client, the server updates the second information sequence number based on the quantity of pieces of new information of the at least one information category, and updates the first information sequence number after updating the incremental quantity of pieces of unread information, so that the client synchronously updates the first information sequence number after the server updates the first information sequence number. In this way, the client and the server complete quantity update in a case in which the information sequence numbers are consistent, avoiding repeated quantity update.

The foregoing descriptions are merely some embodiments and are not intended to limit the protection scope of this application. Any modification, equivalent replacement, or improvement made within the spirit and scope of this application fall within the protection scope of this application.

What is claimed is:

1. An information processing method, performed by an electronic device, the method comprising: displaying a first page of a client, the first page comprising an entry to a second page and an incremental quantity of unread information, the incremental quantity of unread information including a total quantity of unread information received since the second page is displayed last time; displaying, based on a trigger operation on the entry to the second page, the second page comprising a plurality of information categories and a stock quantity of unread information for each of the plurality of information categories, and each respective stock quantity represents an accumulated quantity of unread information in a corresponding information category; and updating, based receiving on new information of at least one information category after the second page is displayed, a stock quantity of unread information corresponding to the at least one information category, and updating the incremental quantity of unread information.

2. The method according to claim 1, wherein the updating a stock quantity comprises: updating, for each of the plurality of information categories, the stock quantity of unread information to a first quantity, the first quantity being a sum of the stock quantity of unread information corresponding to the information category and a quantity of new information of the information category.

3. The method according to claim 1, wherein the updating the incremental quantity comprises: updating the incremental quantity of unread information to a second quantity of information, the second quantity of information being a total quantity of new information of the at least one information category.

4. The method according to claim 3, wherein in a case that the client is in a split-screen display mode, the first page and the second page are both in a displayed state; and the updating the incremental quantity comprises: updating the incremental quantity of unread information displayed on the first page to the second quantity, based on the client being in the split-screen display mode.

5. The method according to claim 3, wherein based on the client in a single-screen display mode, and the second page in a displayed state, the first page in a hidden state, wherein the updating the incremental quantity comprises:updating the incremental quantity of unread information in cached page data of the first page to the second quantity, based on the client in the single-screen display mode, wherein the cached page data is configured to perform page refresh based on the first page switched to a displayed state.

6. The method according to claim 5, wherein the second page further comprises an entry to the first page; and after the updating the incremental quantity of unread information, the method further comprises: displaying the first page based on the cached page data with the page refresh performed, wherein the incremental quantity of unread information on the first page is the second quantity.

7. The method according to claim 6, wherein the first page comprises a plurality of levels of subpages having a level-by-level jump relationship, wherein the plurality of levels of subpages comprise a first subpage and a second subpage, wherein the first subpage is any level of subpage other than a last level of subpage in the plurality of levels of subpages, wherein the second subpage is a next level of subpage of the first subpage, and wherein the second subpage comprises an entry to the first subpage; and the method further comprises: in response to a trigger operation on an entry to the second subpage, in a case that the second subpage is the last level of subpage, displaying the second subpage based on the cached page data with the page refresh performed, wherein the incremental quantity of unread information on the second subpage is the second quantity; and in response to a trigger operation on the entry to the first subpage, displaying the first subpage based on the cached page data with the page refresh performed, wherein the incremental quantity of unread information on the first subpage is the second quantity.

8. The method according to claim 3, wherein before the updating the incremental quantity, the method further comprises: transmitting a first time stamp to a server corresponding to the client, to trigger the server to generate a plurality of first count values, the first time stamp indicating a moment at which the second page starts to be displayed, and the plurality of first count values respectively representing quantities of unread information of the plurality of information categories at the moment corresponding to the first time stamp; transmitting a second time stamp to the server, to trigger the server to generate a plurality of second count values, the second time stamp representing a moment at which the new information of the at least one information category is received, and a plurality of second count values representing quantities of unread information of the plurality of information categories at a moment corresponding to the second time stamp; determining a sub-incremental quantity of unread information of each information category based on a respective second count value and a respective first count value that correspond to each information category; and determining a sum of sub-incremental quantities of unread information corresponding to the plurality of information categories as the second quantity of ; and receiving the second quantity transmitted by the server.

9. The method according to claim 8, wherein a counter runs in the server, the counter comprising a plurality of sub-counters, wherein the server is configured to separately count unread information of the plurality of information categories via the plurality of sub-counters, to obtain the plurality of first count values and the plurality of second count values, and wherein the plurality of first count values are recorded in snapshot data of the counter; and wherein determining the sub-incremental quantity comprises: performing the following operations for each of the plurality of information categories: in response to a quantity of unread information of the information category being not zero, determining a difference between the respective second count value and the respective first count value recorded in the snapshot data as the sub-incremental quantity of unread information of the information category; and in response to the quantity of unread information of the information category being zero, deleting the respective first count value from the snapshot data, and designating the respective second count value as the sub-incremental quantity of unread information of the information category.

10. The method according to claim 1, wherein the second page further comprises a respective entry to a third page corresponding to each of the plurality of information categories; and after the displaying the second page, the method further comprises: in response to a trigger operation on an entry to a third page corresponding to a first information category of the plurality of information categories, displaying the third page corresponding to the first information category and setting the stock quantity of unread information corresponding to the first information category to zero.

11. An information processing apparatus, comprising: at least one memory configured to store program code; and at least one processor configured to read the program code and operate as instructed by the program code, the program code comprising: first display code configured to cause at least one of the at least one processor to display a first page of a client, the first page comprising an entry to a second page and an incremental quantity of unread information, the incremental quantity of unread information including a total quantity of unread information received since the second page is displayed last time; second display code configured to cause at least one of the at least one processor to display, based on a trigger operation on the entry to the second page, the second page comprising a plurality of information categories and a stock quantity of unread information for each of the plurality of information categories, and each respective stock quantity represents an accumulated quantity of unread information in a corresponding information category; and updating code configured to cause at least one of the at least one processor to update, based on receiving new information of at least one information category after the second page is displayed, a stock quantity of unread information corresponding to the at least one information category, and update the incremental quantity of unread information.

12. The apparatus according to claim 11, wherein the updating code is further configured to cause at least one of the at least one processor to: update, for each of the plurality of information categories, the stock quantity of unread information to a first quantity, the first quantity being a sum of the stock quantity of unread information corresponding to the information category and a quantity of new information of the information category.

13. The apparatus according to claim 11, wherein the updating code is further configured to cause at least one of the at least one processor to: update the incremental quantity of unread information to a second quantity of information, the second quantity of information being a total quantity of new information of the at least one information category.

14. The apparatus according to claim 13, wherein in a case that the client is in a split-screen display mode, the first page and the second page are both in a displayed state; and the updating code is further configured to cause at least one of the at least one processor to: update the incremental quantity of unread information displayed on the first page to the second quantity, based on the client being in the split-screen display mode.

15. The apparatus according to claim 13, wherein based on the client in a single-screen display mode, and the second page in a displayed state, the first page in a hidden state, wherein the updating code is further configured to cause at least one of the at least one processor to: update the incremental quantity of unread information in cached page data of the first page to the second quantity, based on the client in the single-screen display mode, wherein the cached page data is configured to perform page refresh based on the first page switched to a displayed state.

16. The apparatus according to claim 15, wherein the second page further comprises an entry to the first page; and wherein the program code further comprises: refresh code configured to cause at least one of the at least one processor to display the first page based on the cached page data with the page refresh performed, wherein the incremental quantity of unread information on the first page is the second quantity.

17. The apparatus according to claim 16, wherein the first page comprises a plurality of levels of subpages having a level-by-level jump relationship, wherein the plurality of levels of subpages comprise a first subpage and a second subpage, wherein the first subpage is any level of subpage other than a last level of subpage in the plurality of levels of subpages, wherein the second subpage is a next level of subpage of the first subpage, and wherein the second subpage comprises an entry to the first subpage; and wherein the refresh code is further configured to cause at least one of the at least one processor to: in response to a trigger operation on an entry to the second subpage, in a case that the second subpage is the last level of subpage, display the second subpage based on the cached page data with the page refresh performed, wherein the incremental quantity of unread information on the second subpage is the second quantity; and in response to a trigger operation on the entry to the first subpage, display the first subpage based on the cached page data with the page refresh performed, wherein the incremental quantity of unread information on the first subpage is the second quantity.

18. The apparatus according to claim 13, wherein the program code further comprises: transmission code configured to cause at least one of the at least one processor to transmit a first time stamp to a server corresponding to the client, to trigger the server to generate a plurality of first count values, the first time stamp indicating a moment at which the second page starts to be displayed, and the plurality of first count values respectively representing quantities of unread information of the plurality of information categories at the moment corresponding to the first time stamp; second transmission code configured to cause at least one of the at least one processor to transmit a second time stamp to the server, to trigger the server to generate a plurality of second count values, the second time stamp representing a moment at which the new information of the at least one information category is received, and a plurality of second count values representing quantities of unread information of the plurality of information categories at a moment corresponding to the second time stamp; determination code configured to cause at least one of the at least one processor to determine a sub-incremental quantity of unread information of each information category based on a respective second count value and a respective first count value that correspond to each information category; and sum code configured to cause at least one of the at least one processor to determine a sum of sub-incremental quantities of unread information corresponding to the plurality of information categories as the second quantity; and receiving code configured to cause at least one of the at least one processor to receive the second quantity transmitted by the server.

19. The apparatus according to claim 18,wherein a counter runs in the server, the counter comprising a plurality of sub-counters, wherein the server is configured to separately count unread information of the plurality of information categories via the plurality of sub-counters, to obtain the plurality of first count values and the plurality of second count values, and wherein the plurality of first count values are recorded in snapshot data of the counter; and wherein the determination code is further configured to cause at least one of the at least one processor to: perform the following operations for each of the plurality of information categories: in response to a quantity of unread information of the information category being not zero, determine a difference between the respective second count value and the respective first count value recorded in the snapshot data as the sub-incremental quantity of unread information of the information category; and in response to the quantity of unread information of the information category being zero, delete the respective first count value from the snapshot data, and designate the respective second count value as the sub-incremental quantity of unread information of the information category.

20. A non-transitory computer-readable storage medium, storing computer code which, when executed by at least one processor, causes the at least one processor to at least: display a first page of a client, the first page comprising an entry to a second page and an incremental quantity of unread information, the incremental quantity of unread information including a total quantity of unread information received since the second page is displayed last time; display, based on a trigger operation on the entry to the second page, the second page comprising a plurality of information categories and a stock quantity of unread information for each of the plurality of information categories, and each respective stock quantity represents an accumulated quantity of unread information in a corresponding information category; and update, based on receiving new information of at least one information category after the second page is displayed, a stock quantity of unread information corresponding to the at least one information category, and update the incremental quantity of unread information.
